(19) United States
(12) Patent Application Publication
(10) Pub. No.: US 2012/0219325 A1
(43) Pub. Date: Aug. 30, 2012

(54) Developing Device, Image Forming Apparatus, and Recovery Device

(75) Inventors: Tsutomu SASAKI, Matsumoto-shi (JP); Kazuma MIYAZAWA, Shiojiri-shi (JP); Kazuhiro NISHIYAMA, Shiojiri-shi (JP); Naoyuki OKUMURA, Shimosuwa-machi (JP); Akihiro GOMI, Fujimi-machi (JP)

(73) Assignee: SEIKO EPSON CORPORATION, Tokyo (JP)

(21) Appl. No.: 13/396,493

(22) Filed: Feb. 14, 2012

(30) Foreign Application Priority Data
Feb. 24, 2011 (JP) 2011-038276
Mar. 3, 2011 (JP) 2011-046141
Mar. 8, 2011 (JP) 2011-050440
May 23, 2011 (JP) 2011-114420

(51) Int. Cl. G03G 15/10

(52) U.S. Cl. 399/237

(57) ABSTRACT

In a developing device which supplies a liquid developer to a developer holder roller using a supply member and performs development using the liquid developer, and an image forming apparatus including the developing device, a developer holder cleaning unit which cleans the developer holder roller and recovers the liquid developer in order to prevent the liquid developer after development from being adhered to the supply member, a supply member cleaning unit which cleans the supply member and recovers the liquid developer, a recovery path member which is disposed above the supply member in a vertical direction and receives the liquid developer recovered by the developer holder cleaning unit, and a recovery unit which is disposed above the recovery path member in the vertical direction and stores the liquid developer moved to the recovery path member and the liquid developer recovered by the supply member cleaning unit are provided.

### BACKGROUND

1. Technical Field

The present invention relates to a developing device which performs development with a liquid developer containing a toner and a carrier liquid, an image forming apparatus including the developing device, a recovery device which recovers a liquid developer containing a toner and a carrier liquid, and a developing device and an image forming apparatus including the recovery device.

2. Related Art

Hitherto, an image forming apparatus of a liquid developing type in which an electrostatic latent image is formed on a charged photoconductor and the electrostatic latent image is developed by a liquid developer made by dispersing a toner in a carrier liquid thereby forming a toner image has been commercialized. For example, in an image forming apparatus described in JP-A-2010-185984 (FIG. 5), a liquid developer is supplied to a developing roller via an intermediate roller (supply roller) so as to be held by the developing roller. In addition, a latent image on the surface of a photoconductive drum is developed by the liquid developer on the developing roller, and thereafter the liquid developer remaining on the developing roller after passing through a development position is scraped by a cleaner blade of the developing roller.

However, in the apparatus according to the related art, the liquid developer scraped by the cleaner blade of the developing roller drops onto the intermediate roller and thereafter is scraped by a cleaner blade of the intermediate roller which abuts on the surface of the intermediate roller so as to be recovered. Therefore, the following problems may occur. Since agglutinated toner is contained in the liquid developer remaining on the surface of the developing roller after the developing process, when the agglutinated toner is adhered to the intermediate roller, cleaning defects occur in the intermediate roller, resulting in degradation of image quality.

### SUMMARY

An advantage of some aspects of the invention is that it provides, in a developing device which supplies a liquid developer containing a toner and a carrier liquid to a supply member and performs development with the liquid developer and an image forming apparatus including the developing device, a technique for preventing the liquid developer from being adhered to the supply member after the development.

According to a first aspect of the invention, there is provided a developing device including: a developer holder roller which holds a liquid developer containing a toner and a carrier liquid; a supply member which supplies the liquid developer to the developer holder roller; a developer roller cleaning unit which cleans the developer holder roller and recovers the liquid developer; a supply member cleaning unit which cleans the supply member and recovers the liquid developer; a recovery path member which is disposed above the supply member in a vertical direction and receives the liquid developer recovered by the developer holder cleaning unit; and a recovery unit which is disposed below the recovery path member in the vertical direction and stores the liquid developer moved to the recovery path member and the liquid developer recovered by the supply member cleaning unit.

According to a second aspect of the invention, there is provided an image forming apparatus including: a latent image holder on which a latent image is formed; and a developing unit which includes a developer holder roller that holds a liquid developer containing a toner and a carrier liquid, a supply member which supplies the liquid developer to the developer holder roller, a developer roller cleaning unit which cleans the developer holder roller and recovers the liquid developer, a supply member cleaning unit which cleans the supply member and recovers the liquid developer, a recovery path member which is disposed above the supply member in a vertical direction and receives the liquid developer recovered by the developer holder cleaning unit, and a recovery unit which is disposed below the recovery path member in the vertical direction and stores the liquid developer moved to the recovery path member and the liquid developer recovered by the supply member cleaning unit, and develops the latent image formed on the latent image holder.

In the aspects of the invention (the developing device and the image forming apparatus) configured as described above, the developer holder cleaning unit recovers the liquid developer from the developer holder roller, and the recovered liquid developer is received by the recovery path member disposed above the supply member in the vertical direction. Therefore, the liquid developer recovered from the developer holder roller can be prevented from being adhered to the supply member.

### BRIEF DESCRIPTION OF THE DRAWINGS

The invention will be described with reference to the accompanying drawings, wherein like numbers reference like elements.

FIG. 1 is a diagram illustrating an image forming apparatus including a developing device according to a first embodiment of the invention.

FIG. 2 is a perspective view illustrating an overall configuration of a cleaning mechanism of a developing unit.

FIG. 3 is a diagram illustrating abutting angles of cleaning blades.

FIG. 4 is a diagram illustrating a dimension relationship between members constituting the cleaning mechanism.

FIG. 5 is a schematic diagram illustrating a recovery path of a waste liquid recovered by the cleaning mechanism.

FIG. 6 is a diagram illustrating a comparative example of the developing device.

FIG. 7 is a diagram illustrating a developing device according to a third embodiment of the invention.

FIG. 8 is a diagram illustrating a developing device according to a fourth embodiment of the invention.

FIG. 9 is a diagram showing cleaning performance of cleaning by rollers and blades.

FIG. 10 is a diagram illustrating an image forming apparatus including a developing device according to a fifth embodiment of the invention.

FIG. 11 is a diagram illustrating a developing unit which is the developing device according to the fifth embodiment of the invention.

FIG. 12 is a diagram viewed from a side opposite to a photoconductive drum.

FIG. 13 is a diagram illustrating a cleaning unit of a developing roller.

FIG. 14 is a partially enlarged view of a recovery path member.

FIG. 15 is a diagram illustrating a developing unit which is a developing device according to a sixth embodiment of the invention.

FIG. 16 is a diagram illustrating a developing unit which is a developing device according to a seventh embodiment of the invention.

FIG. 17 is a diagram illustrating an image forming apparatus including a developing device according to an eighth embodiment of the invention.

FIG. 18 is a perspective view illustrating an overall configuration of a cleaning mechanism of the developing unit.

FIGS. 19A and 19B are diagrams illustrating abutting angles of cleaning blades according to the eighth embodiment.

FIG. 20 is a schematic diagram illustrating a recovery path of a waste liquid recovered by the cleaning mechanism.

FIG. 21 is a diagram illustrating an image forming apparatus including a developing device according to a ninth embodiment of the invention.

FIGS. 22A and 22B are diagrams illustrating abutting angles of cleaning blades according to the ninth embodiment.

FIG. 23 is a diagram illustrating an image forming apparatus including a developing device according to a tenth embodiment of the invention.

FIG. 24 is a diagram illustrating a developing unit included in the image forming apparatus of FIG. 23.

FIG. 25 is a schematic diagram illustrating a recovery path of a recovery liquid recovered by the developing unit.

FIG. 26 is a diagram viewed from a side opposite to a photoconductive drum.

FIG. 27 is a diagram illustrating a cleaning unit of a developing roller.

FIG. 28 is a partially enlarged view of a recovery path member.

FIG. 29 is a diagram illustrating a developing unit including a developing device according to an eleventh embodiment of the invention.

### DESCRIPTION OF EXEMPLARY EMBODIMENTS

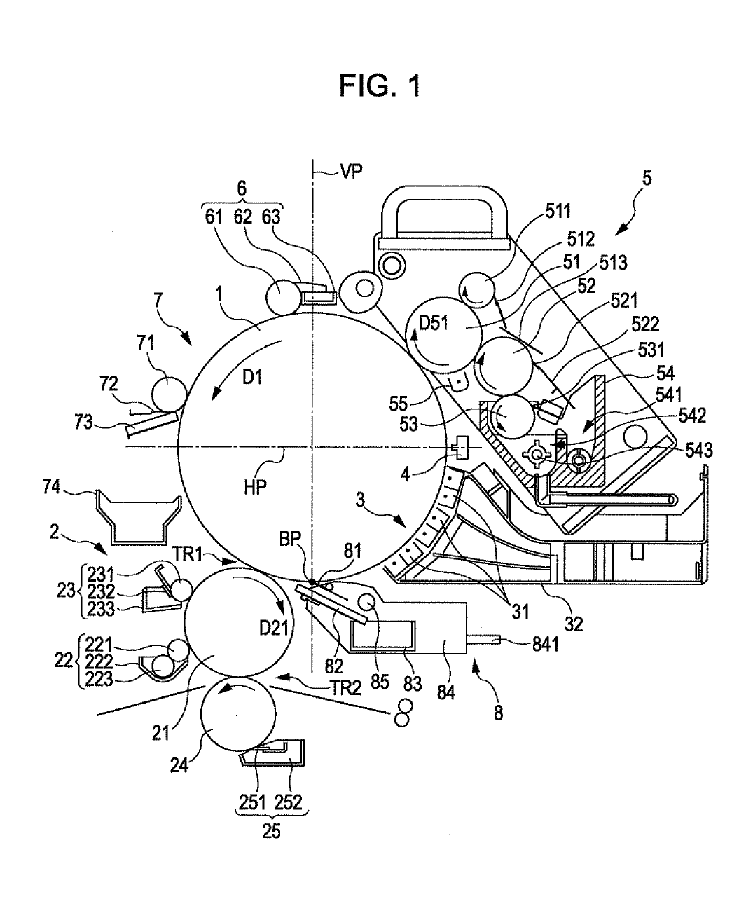

FIG. 1 is a diagram illustrating an image forming apparatus including a developing device according to a first embodiment of the invention. The image forming apparatus has a so-called lower part transfer structure in which an image held on a photoconductive drum 1 below a virtual horizontal plane HP passing through the rotation center of the photoconductive drum 1 in the vertical direction is transferred to a blanket roller 21 of a primary transfer unit 2, and the image transferred onto the blanket roller 21 is further transferred onto transfer paper. In addition, as described later, the image forming apparatus of FIG. 1 forms a toner image with a single color so as to be transferred onto transfer paper, and a plurality of the same apparatuses, for example, four apparatuses may be arranged to constitute a color printing system. Of course, the apparatus of FIG. 1 also functions as a monochrome image forming apparatus alone.

In the image forming apparatus, the photoconductive drum 1 has a photoconductive layer made of a photoconductive material such as an amorphous silicon photoconductor on the surface. In addition, the photoconductive drum 1 is disposed so that the rotation axis thereof is parallel or substantially parallel to the main scanning direction (a direction perpendicular to FIG. 1) and is rotatably driven in the direction of the arrow D1 in FIG. 1 at a predetermined speed.

In the periphery of the photoconductive drum 1, a charging unit 3 that charges the surface of the photoconductive drum 1 to a predetermined potential, an exposure unit 4 that exposes the surface of the photoconductive drum 1 according to an image signal so as to form an electrostatic latent image, a developing unit 5 that develops the electrostatic latent image with a liquid developer so as to form a toner image, a first squeeze unit 6, a second squeeze unit 7, the blanket roller 21 of the primary transfer unit 2, and a photoconductor cleaning unit 8 that cleans the surface of the photoconductive drum 1 after primary transfer are arranged in this order along the rotation direction D1 (counterclockwise in FIG. 1) of the photoconductive drum 1.

The charging unit 3 has 6 chargers 31 and charger air flow ducts 32 and is disposed on the right with respect to a virtual vertical plane VP passing through the rotation center of the photoconductive drum 1 in FIG. 1 and below the virtual horizontal plane HP passing through the rotation center of the photoconductive drum 1 in the vertical direction. The chargers 31 do not come into contact with the surface of the photoconductive drum 1, and the 6 chargers 31 are arranged along the rotation direction D1 of the photoconductive drum 1. As the charger 31, for example, a corona charger which has been well known hitherto may be used. In a case where a scorotron charger is used as the corona charger, a wire current flows through a charging wire of the scorotron charger and a DC grid charging bias is applied to a grid. As the photoconductive drum 1 is charged by corona discharge using the chargers 31 as such, the potential of the surface of the photoconductive drum 1 is set to a substantially uniform potential. In addition, the charger air flow duct 32 has an external air introduction path (not shown) that introduces external air toward the charger 31 and an air exhaust path (not shown) that exhausts an atmosphere generated by discharge in the charger 31 so as to ventilate the atmosphere in which a charging process is performed, thereby performing atmosphere management.

The exposure unit 4 is disposed on the right with respect to the virtual vertical plane VP in FIG. 1 and on the virtual horizontal plane HP and exposes the surface of the photoconductive drum 1 using light beams according to the image signal given from an external device, thereby forming an electrostatic latent image corresponding to the image signal. In this embodiment, a line head in which light-emitting elements are arranged in the main scanning direction (the direction perpendicular to FIG. 1) is used as the exposure unit 4 and may also use one in which light beams from semiconductor lasers are scanned in the main scanning direction by a polygon mirror and the like. In addition, in this embodiment, the exposure unit 4 is disposed on the virtual horizontal plane HP. However, the disposition position of the exposure unit 4 is not limited to this, and the exposure unit 4 may be disposed above or below the virtual horizontal plane HP in the vertical direction.

The liquid developer is given from the developing unit 5 which is the developing device according to the first embodiment of the invention to the electrostatic latent image formed as described above, such that the electrostatic latent image is developed by the toner. In this embodiment, the liquid developer in which a weight ratio of about 25% of colored resin particles are disposed as the toner in a carrier liquid mainly containing an insulating liquid is used, and the toner has charges so as to be subjected to electrophoresis in an electric field. In addition, the concentration of the developer is not limited to 25% described above and may be 10 to 30%. As the carrier liquid, for example, Isopar (a trademark of Exxon Corporation), a silicon oil, a normal paraffin oil, or the like is used.

The electric resistance is equal to or higher than 10¹⁰ Ω·cm and preferably equal to or higher than 10¹² Ω·cm. This is because if the resistance is low, surplus current flows during electrophoresis of the toner and thus there is a possibility that an electric field needed for movement cannot be maintained. Moreover, the viscosity of the liquid developer prepared as described above depends on resins included in the toner, a dispersant, or a charge control agent, and a liquid developer having a viscosity of 50 to 500 mPa·s may be used. In this embodiment, a liquid developer of 400 mPa·s is used. The configuration and operation of the developing unit 5 will be described in detail as follows.

On the downstream side of the rotation direction D1 of the photoconductive drum 1 with respect to the development position where the electrostatic latent image is developed by the liquid developer, the first squeeze unit 6 is disposed, and on the downstream side of the first squeeze unit 6, the second squeeze unit 7 is disposed. In this embodiment, a squeeze roller 61 of the first squeeze unit 6 and a squeeze roller 71 of the second squeeze unit 7 are both disposed on the left with respect to the virtual vertical plane VP in FIG. 1 and above the virtual horizontal plane HP in the vertical direction.

In the first squeeze unit 6, the squeeze roller 61 which is impelled against the photoconductive drum 1 by a spring (not shown) is provided. The squeeze roller 61 is rotatably driven by a motor (not shown) while abutting on the surface of the photoconductive drum 1 at a first squeeze position, thereby removing a surplus developer of the toner image. In order to increase the squeezing efficiency, this embodiment employs a configuration in which a first squeezing bias generation unit (not shown) is electrically connected to the squeeze roller 61 so as to apply a first squeezing bias at an appropriate timing. In addition, a cleaning blade 62 abuts on the surface of the squeeze roller 61 to scrape the liquid developer adhered to the roller surface. The liquid developer scraped as described above is recovered by a recovery member 63.

In addition, in the second squeeze unit 7, the squeeze roller 71 is rotated while abutting on the surface of the photoconductive drum 1 at a second squeeze position on the downstream side of the first squeeze position in the rotation direction D1 of the photoconductive drum 1, thereby removing a surplus carrier liquid or fog toner of the toner image. In order to increase the squeezing efficiency, this embodiment employs a configuration in which, similarly to the first squeeze unit 6, a second squeezing bias generation unit (not shown) is electrically connected to the squeeze roller 71 so as to apply a second squeezing bias at an appropriate timing. In addition, a cleaning blade 72 abuts on the surface of the squeeze roller 71 to scrape the liquid developer adhered to the roller surface. The liquid developer scraped as described above is guided by a guide member 73 in a direction further away from the photoconductive drum 1 so as to be recovered by a recovery member 74 disposed below the guide member 73 in the vertical direction.

In addition, in this embodiment, the two squeeze units 6 and 7 are provided. However, the number of squeeze units, the disposition thereof, and the like are not limited to this and for example, a single squeeze unit may be disposed.

The toner image corresponding to the image signal given from the outside of the apparatus is formed on the photoconductive drum 1 that passes through the first and second squeeze units 6 and 7 and is transferred onto the blanket roller 21 at a primary transfer position TR1. The transfer unit 2 including the blanket roller 21 is disposed on the left with respect to the virtual vertical plane VP in FIG. 1 and below the virtual horizontal plane HP in the vertical direction. The transfer unit 2 has the blanket roller 21, a carrier application mechanism 22 that applies the carrier liquid to the blanket roller 21, a cleaning mechanism 23 of the blanket roller 21, a secondary transfer roller 24, and a cleaning mechanism 25 of the secondary transfer roller 24.

The surface of the blanket roller 21 abuts on the surface of the photoconductive drum 1 on the upstream side of the rotation direction D1 of the photoconductive drum 1 with respect to a position (hereinafter, referred to as a “lowest position”) BP intersecting the virtual vertical plane VP in the vertical direction at the lower side in the vertical direction of the photoconductive drum 1, thereby forming a primary transfer nip. A formation position of the primary transfer nip becomes the primary transfer position TR1. In addition, the blanket roller 21 is connected to a motor of which illustration is omitted and is rotatably driven clockwise D21 in FIG. 1 so as to rotate along with the photoconductive drum 1. A toner image held by the photoconductive drum 1 as described above is primarily transferred onto the blanket roller 21 at the primary transfer position TR1.

In addition, the secondary transfer roller 24 rotates along with the blanket roller 21 while abutting on the blanket roller 21 on the downstream side of the primary transfer position TR1 in the rotation direction D21 of the blanket roller 21, thereby forming a secondary transfer nip. A formation position of the secondary transfer nip becomes a secondary transfer position TR2. Therefore, transfer paper is fed to the secondary transfer position TR2 by a transportation unit of which illustration is omitted so as to pass through the secondary transfer nip, such that the toner image transferred onto the blanket roller 21 is secondarily transferred onto the transfer paper. In this manner, an image using the liquid developer is printed on the transfer paper.

In addition, the carrier application mechanism 22 is disposed on the downstream side of the secondary transfer position TR2 in the rotation direction D21 of the blanket roller 21 and applies a carrier liquid to the surface of the blanket roller 21 after secondary transfer. In order to perform the process of applying the carrier liquid, the carrier application mechanism 22 has a carrier application roller 221 which rotates along with the blanket roller 21, a carrier storage member 222 which stores the carrier liquid, and a carrier drawing-up roller 223 which draws up the carrier liquid from the carrier storage member 222 so as to be supplied to the carrier application roller 221.

The cleaning mechanism 23 is disposed on the downstream side of the carrier application mechanism 22 in the rotation direction D21 of the blanket roller 21 and on the upstream side of the primary transfer position TR1 so as to clean the surface of the blanket roller 21 immediately before primary transfer. In order to perform the cleaning process, the cleaning mechanism 23 has a cleaning roller 231 which rotates in the counter direction to the blanket roller 21, a cleaning blade 232 which abuts on the cleaning roller 231 and cleans the cleaning roller 231, and a recovery member 233 which recovers toner or carrier liquid scraped by the cleaning blade 232.

The cleaning mechanism 25 is disposed on the upstream side of the secondary transfer position TR2 in the rotation direction of the secondary transfer roller 24 so as to clean the surface of the secondary transfer roller 24 immediately before secondary transfer. In order to perform the cleaning process, the cleaning mechanism 25 has a cleaning blade 251 which abuts on the secondary transfer roller 24 and cleans the secondary transfer roller 24, and a recovery member 252 which recovers toner or carrier liquid scraped by the cleaning blade 251.

The photoconductor cleaning unit 8 is disposed on the downstream side of the primary transfer position TR1 in the rotation direction D1 of the photoconductive drum 1 and on the upstream side of the charging position. The photoconductor cleaning unit 8 has a cleaning blade 81, a developer receiving member 82 which receives liquid developer dripping from the lowest position BP of the photoconductive drum 1, a recovery member 83 which receives the developer received by the developer receiving member 82, and a support member 84 which integrally supports the cleaning blade 81, the developer receiving member 82, and the recovery member 83. The support member 84 is rotatable about a rotation shaft 85 as the rotation center.

A spring member (not shown) is connected to the support member 84 so as to impel the support member 84 counterclockwise in FIG. 1 and operate the cleaning blade 81 in a direction away from the photoconductive drum 1. On the other hand, an engagement portion 841 is provided to protrude from an end portion of the support member 84 on the opposite side to the photoconductive drum (on the right of FIG. 1), and when a movable piece of which illustration is omitted presses the engagement portion 841 at a stress greater than the impelling force, the support member 84 is rotated clockwise in FIG. 1, such that the cleaning blade 81 moves toward the photoconductive drum 1 and the front end portion of the cleaning blade 81 abuts on the lowest position BP of the photoconductive drum 1. Accordingly, the liquid developer remaining on the photoconductive drum 1 is cleaned and removed. In addition, the liquid developer scraped by the cleaning blade 81 is received by the developer receiving member 82 disposed below the lowest position BP of the photoconductive drum 1 in the vertical direction, and flows down into the recovery member 83 along the inclined surface of the developer receiving member 82 so as to be stored.

Next, the configuration and the operation effects of the developing unit 5 will be described with reference to FIGS. 1 to 5. As illustrated in FIG. 1, the developing unit has a so-called three-roller configuration including a developing roller 51, an intermediate application roller 52, and an anilox roller 53. Each of the rollers 51 to 53 is disposed so that the rotation axis is parallel to the rotation axis of the photoconductive drum 1 and both end portions are axially supported by a pair of side plates of which illustration is omitted, so as to be rotatable. More specifically, each of the rollers 51 to 53 is configured as follows.

The developing roller 51 is a cylindrical member and is made by providing an elastic layer such as polyurethane rubber, silicon rubber, or NBR on the outer peripheral portion of an inner core made of a metal such as iron and coating a PFA tube or resin on the surface layer of the developing roller which is a further outer peripheral portion. The developing roller 51 is connected to a developing motor (not shown) and is driven to rotate clockwise D51 in FIG. 1 so as to rotate along with the photoconductive drum 1. In addition, the developing roller 51 is electrically connected to a developing bias generation unit of which illustration is omitted so that a developing bias is applied to the developing roller 51 at an appropriate timing.

In addition, in order to supply the liquid developer to the developing roller 51, the intermediate application roller 52 and the anilox roller 53 are provided, and the liquid developer is supplied to the developing roller 51 from the anilox roller 53 via the intermediate application roller 52. Of the rollers, the intermediate application roller 52 is made by providing an elastic layer on the outer peripheral portion of an inner core made of metal similarly to the developing roller 51, and the anilox roller 53 is a roller in which a concave pattern is formed of spiral grooves or the like carved finely and uniformly on the surface so as to easily hold the liquid developer. Of course, similarly to the developing roller 51 or the intermediate application roller 52, the anilox roller 53 may use one made by winding a rubber layer such as urethane or NBR or coating a PFA tube around a metal core. The intermediate application roller 52 and the anilox roller 53 are connected to the developing motor and are rotated clockwise and counterclockwise in FIG. 1, respectively. Therefore, the intermediate roller 52 is rotated in the counter direction to the developing roller 51, and the anilox roller 53 is rotated along with the intermediate application roller 52. As described above, in this embodiment, since the liquid developer is supplied to the developing roller 51 from a developer container 54 by the so-called three-roller configuration, as the liquid developer passes through the nips a plurality of times, the liquid developer can be kneaded, and thus a uniform liquid developer film can be formed on the developing roller 51.

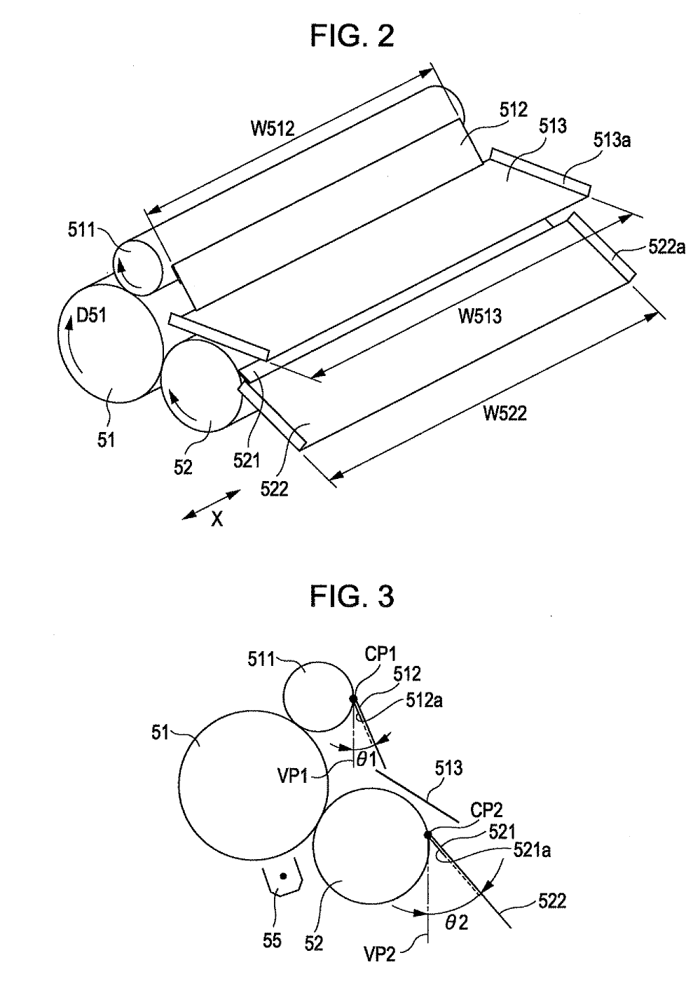

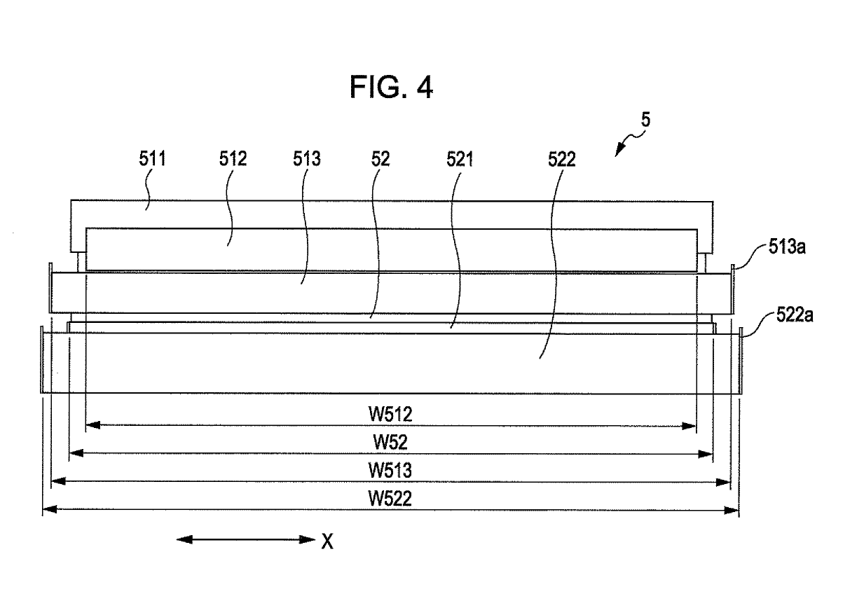

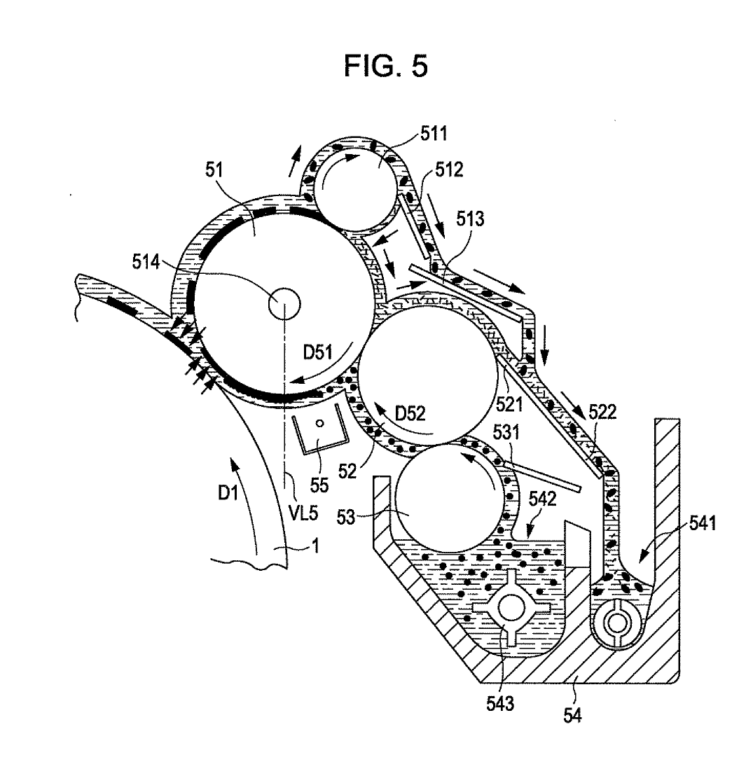

FIG. 2 is a perspective view illustrating an overall configuration of a cleaning mechanism of the developing roller and the intermediate application roller. FIG. 3 is a diagram illustrating abutting angles of a developing roller cleaning blade and an intermediate application roller cleaning blade. FIG. 4 is a diagram illustrating a dimension relationship between members constituting the cleaning mechanism. FIG. 5 is a schematic diagram illustrating a recovery path of a waste liquid recovered by the cleaning mechanism.

As illustrated in FIGS. 1, 2, and 5, a cleaning roller 511 abuts on the developing roller 51, and a roller cleaning blade 512 abuts on the cleaning roller 511 so as to perform a cleaning process on the developing roller 51. That is, the cleaning roller 511 is rotated clockwise in FIGS. 3 and 4 while abutting on the surface of the developing roller 51 on the downstream side of the developing roller rotation direction D51 with respect to a developing position where the surface of the developing roller 51 abuts on the photoconductive drum 1 and forms a development nip. Therefore, the cleaning roller 511 is rotated in the counter direction to the developing roller 51, and thus does not contribute to development and removes the liquid developer remaining on the developing roller 51. In addition, the roller cleaning blade 512 abuts on the surface of the cleaning roller 511 at an abutting angle θ1 to scrape off and remove the liquid developer. That is, an angle between a vertical virtual plane extending downward in the vertical direction from a first abutting portion CP1 where the roller cleaning blade 512 abuts on the cleaning roller 511, that is, a first vertical virtual plane VP1 configured of a vertical plane including the first abutting portion CP1 and a lower surface 512a of the roller cleaning blade 512 in the vertical direction is the abutting angle θ1 set in advance. In this embodiment, as illustrated in FIG. 3, the liquid developer remaining on the developing roller 51 is scraped by the roller cleaning blade 512 via the cleaning roller 511. The cleaning roller 511 and the roller cleaning blade 512 constitute a “developer holder cleaning unit” of the invention, and the roller cleaning blade 512 thereof functions as a “developer holder cleaning blade” of the invention.

An inclined member 513 is disposed below the roller cleaning blade 512 in the vertical direction and above the intermediate application roller 52 in the vertical direction. An end portion of the inclined member 513 on the developing roller side (on the left of FIG. 1) is higher than an end portion thereof on the opposite side to the developing roller (on the right of FIG. 1) and the inclined member 513 is inclined downward in the vertical direction as it goes from the developing roller 51. In addition, the inclined member 513 is fixed to a developing device support unit (not shown) so that the end portion thereof on the developing roller side is positioned below the roller cleaning blade 512 in the vertical direction. In this embodiment, as illustrated in FIGS. 2 and 4, the length W513 of the inclined member 513 in the rotation axis direction X is greater than the length W512 of the roller cleaning blade 512 in the rotation axis direction X, that is,

### W513>W512.

Moreover, as illustrated, in FIG. 4, the length W513 of the inclined member 513 in the rotation axis direction X is greater than the length W52 of the intermediate application roller 52 in the rotation axis direction X, that is,

### W513>W52.

Therefore, the inclined member 513 receives all the liquid developer (waste liquid) recovered by the roller cleaning blade 512 without dropping the liquid developer onto the intermediate application roller 52 so as to be guided in a direction to the side opposite to the developing roller away from the intermediate application roller 52. In addition, as illustrated in FIGS. 2 and 4, fences 513a extending upward are formed at both end portions of the inclined member 513 in the rotation axis direction X so as to prevent the waste liquid from overflowing from both end portions of the inclined member 513, so that the waste liquid can be reliably recovered. As described above, the inclined member 513 functions as a “recovery path member” of the invention.

The cleaning blade 521 abuts on the intermediate application roller 52 at an abutting angle θ2 and thus does not contribute to development and scrapes off the liquid developer remaining on the intermediate application roller 52 from the surface of the intermediate application roller 52 so as to be removed. That is, as illustrated in FIG. 3, an angle between a vertical virtual plane extending downward in the vertical direction from a second abutting portion CP2 where the cleaning blade 521 abuts on the intermediate application roller 52, that is, a second vertical virtual plane VP2 configured of a vertical plane including the second abutting portion CP2 and a lower surface 521a of the cleaning blade 521 in the vertical direction is the abutting angle θ2 (>θ1) set in advance. As described above, in this embodiment, the intermediate application roller 52 corresponds to a “supply member” and a “roller member” of the invention, and the cleaning blade 521 corresponds to a “supply member cleaning unit” and a “supply member cleaning blade”.

An end portion of the cleaning blade 521 on the opposite side to the intermediate application roller (on the right of FIG. 1) is connected to an inclined member 522. An end portion of the inclined member 522 on the intermediate application roller side (on the left of FIG. 1) is higher than an end portion thereof on the opposite side to the intermediate application roller (on the right of FIG. 1) and the inclined member 522 is inclined downward in the vertical direction as it goes from the intermediate application roller 52. In addition, the inclined member 522 is fixed to the developer support unit so that the end portion thereof on the intermediate application roller side is positioned below the end portion of the inclined member 513 on the opposite side to the developing roller, and the end portion thereof on the opposite side to the intermediate application roller is disposed above a recovery unit 541 of the developer container 54 in the vertical direction. In this embodiment, the length W522 of the inclined member 522 in the rotation axis direction X is greater than the length (not shown) of the cleaning blade 521 in the rotation axis direction X. Moreover, the length W522 of the inclined member 522 in the rotation axis direction X is greater than the length W513 of the inclined member 513 in the rotation axis direction X, that is,

### W522>W513.

Accordingly, as illustrated in FIG. 5, all the liquid developer (waste liquid) scraped off by the blade 521 is guided toward the opposite side to the intermediate application roller along the inclined member 522, and the waste liquid guided by the inclined member 513 so as to fall down (the liquid developer cleaned and removed from the developing roller 51) is received by the end portion of the inclined member 522 on the intermediate application roller side which is connected to the cleaning blade 521 in one body so as to be guided toward the opposite side to the intermediate application roller.

The liquid developer (waste liquid) scraped by the blades 512 and 521 flows down to the recovery unit 541 of the developer container 54 from the inclined member 522. In addition, regarding the inclined member 522, similarly to the inclined member 513, fences 522a extending upward are formed at both end portions of the inclined member 522 in the rotation axis direction X so as to prevent the waste liquid from overflowing from both end portions of the inclined member 522, so that the waste liquid can be reliably recovered. As described above, in this embodiment, the recovery unit 541 of the developer container 54 functions as a “recovery unit” of the invention.

On the other hand, a restriction member 531 abuts on the anilox roller 53. As the restriction member 531, a member made of metal or a member having elasticity which is configured by coating an elastic body on the surface may be used. The restriction member 531 according to this embodiment is configured of a rubber portion made of urethane rubber or the like abutting on the surface of the anilox roller 53 and a plate made of metal or the like for supporting the rubber portion. In addition, the restriction member 531 has functions of restricting and adjusting the thickness, the amount, and the like of the liquid developer held and transported by the anilox roller 53 thereby adjusting the amount of the liquid developer supplied to the developing roller 51. In addition, the liquid developer scraped by the restriction member 531 is returned to a storage unit 542 of the developer container 54. An agitating member 543 is disposed in the storage unit 542 and is rotated by a motor of which illustration is omitted so as to agitate the liquid developer in the storage unit 542.

In the above-described manner, the developing roller 51 to which liquid developer is supplied is rotated so as to move in the reverse direction to that of the surface of the intermediate application roller 52 and is rotated so as to move in the same direction as that of the surface of the photoconductive drum 1. In addition, in order to form a toner image, the rotation direction of the surface of the developing roller 51 needs to be the same direction as the surface of the photoconductive drum 1 so that the surfaces thereof rotate along with each other. However, the rotation direction of the developing roller may be configured to be any of the reverse direction to and the same direction as that of the intermediate application roller 52.

A toner compression corona generator 55 is disposed on the upstream side of the rotation direction D51 of the developing roller 51 with respect to the development position. The toner compression corona generator 55 is an electric field application unit that increases a bias of the surface of the developing roller 51, and an electric field is applied to the toner of the liquid developer transported by the developing roller 51 at a position close to the toner compression corona generator 55, thereby performing charging and compression.

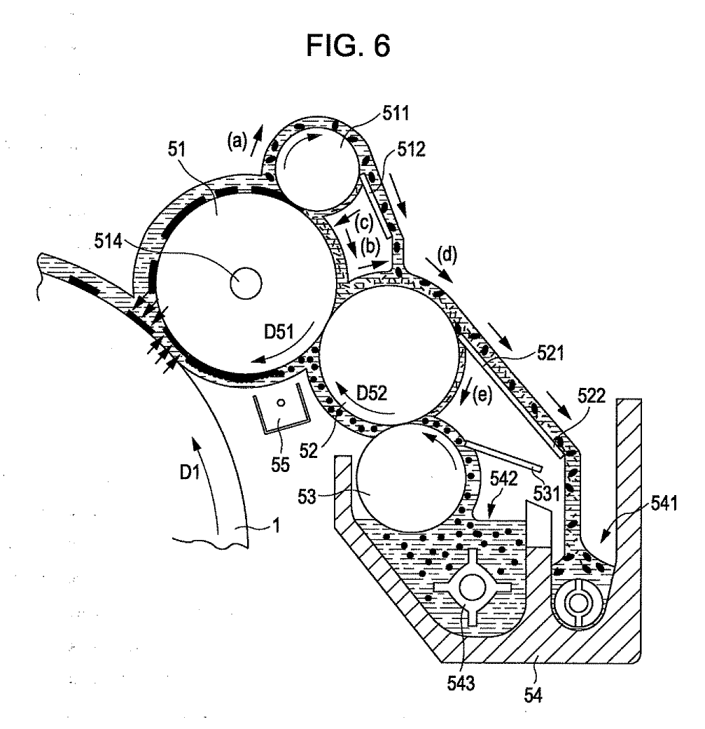

As described above, according to this embodiment, since the inclined member 513 is disposed above the intermediate application roller 52 in the vertical direction, all the liquid developer (waste liquid) recovered by the roller cleaning blade 512 is received by the inclined member 513 and is thus recovered without dropping onto the intermediate application roller 52. Therefore, the liquid developer with a high viscosity which is remained and agglutinated on the developing roller 51 after the developing process can be reliably prevented from being adhered to the intermediate application roller 52, so that cleaning defects of the intermediate application roller 52 can be avoided. In order to further clarify the operation effects of this embodiment, a comparative example (FIG. 6) is exemplified and described in detail.

FIG. 6 is a schematic diagram illustrating a recovery path of a waste liquid recovered by a cleaning mechanism according to the comparative example. This comparative example is significantly different from the first embodiment in that the inclined member 513 is not provided and other configurations thereof are basically the same as those of the first embodiment. In FIG. 6, in order to describe the flow of a liquid developer in the comparative example, reference numerals (a) to (e) representing the flows of the liquid developer are shown. Hereinafter, the flows of the liquid developer in the comparative example and problems thereof will be described with reference to appropriate reference numerals.

The viscosities of the liquid developer adhered to the developing roller 51, the cleaning roller 511, and the roller cleaning blade 512 of the comparative example are the same as those of the first embodiment, and the viscosities of the liquid developer at flow parts (a) to (c) illustrated in FIG. 6 are as follows.

Flow part (a): 400 to 540 mPa·S
Flow part (b): 100 mPa·S
Flow part (c): 200 mPa·S

The liquid developer that is present in the flow part (a) is recovered from the developing roller 51 and is a liquid developer after development. Therefore, toner is present in the liquid developer while being compressed and agglutinated, so that the liquid developer has large particle sizes, poor dispersibility, and high viscosity. Accordingly, in the roller cleaning blade 512, residues after cleaning, that is, the flow part (c) occurs. In addition, in the flow part (b), the liquid developer passing through the nip between the developing roller 51 and the cleaning roller 511 flows. The toner contained in the liquid developer is crushed by the nip while passing through the nip. In addition, the liquid developer flowing into the flow part (c) joins the liquid developer flowing into the flow part (b), is scraped by the intermediate application roller 52, and is cleaned and removed by the cleaning blade 521 abutting on the intermediate application roller 52.

However, in the comparative example, as described above, since the inclined member 513 is not provided, the liquid developer flowing into the flow part (a) drops onto the intermediate application roller 52 and is mixed with the crushed toner. Therefore, the viscosity of the liquid developer in the flow part (d) is slightly reduced to:

Flow part (d): 300 to 400 mPa·S
and thus is easily cleaned and removed. However, at the cleaning blade 521 of the intermediate application roller 52, residues after cleaning occur, and accordingly the flow part (e) occurs. This can be understood by a cleaning performance evaluation described later in examples. In the comparative example, cleaning defects occur and this is one of the main factors of degradation of image quality.

Contrary to this, in the first embodiment, since the inclined member 513 is provided, the liquid developer flowing into the flow part (a) in FIG. 6 can be prevented from dropping onto the intermediate application roller 52, thereby preventing cleaning defects of the intermediate application roller 52. As a result, an image can be formed with excellent image quality.

In addition, in the embodiment, as illustrated in FIG. 2, the length W512 of the roller cleaning blade 512 in the rotation axis direction X, the length W513 of the inclined member 513 in the rotation axis direction X, and the length W522 of the inclined member 522 in the rotation axis direction X have the following relationship:

### W522>W513>W512.

Therefore, the liquid developer (waste liquid) recovered by the roller cleaning blade 512 is recovered and stored in the recovery unit 541 of the developer container 54 via the inclined members 513 and 522.

In the embodiment, as described above, since toner is present in the liquid developer recovered by the roller cleaning blade 512 (that is, the liquid developer flowing through the flow part (a) in FIG. 6) while being compressed and agglutinated, the liquid developer has large particle sizes, poor dispersibility, and high viscosity and thus is more difficult to be cleaned and removed than the liquid developer (that is, the liquid developer flowing through the flow part (b) in FIG. 6) adhered to the intermediate application roller 52. In consideration of the difference in characteristics of the liquid developer at each part of the apparatus, as illustrated in FIG. 3, it is preferable that the abutting angle θ1 of the roller cleaning blade 512 be configured to be smaller than the abutting angle θ2 of the cleaning blade 521, and accordingly, the toner is prevented from being collected in the abutting portion CP1, that is, the blade front end of the roller cleaning blade 512. In addition, preferably, the abutting angles θ1 and θ2 are set as follows:

θ1≦40°
θ1<θ2≦60°.

In the first embodiment, the abutting angles θ1 and θ2 are set to 20° and 40°, respectively.

As described above, a configuration may be employed in which the supply member is configured as a roller member rotating while holding the liquid developer and the length of the supply member of the recovery path member in the axial direction is greater than the length of the supply member in the axial direction.

In addition, a configuration may be employed in which a developer holder cleaning unit has a developer holder cleaning blade that moves the recovered liquid developer, and the recovery path member is connected to the developer holder cleaning blade.

In addition, a configuration may be employed in which the supply member cleaning unit has the supply member cleaning blade, and the liquid developer moved by the recovery path member is moved by the supply member cleaning blade so as to be stored in the recovery unit.

In addition, a configuration may be employed in which, assuming that a vertical plane including the first abutting portion where the developer holder cleaning blade abuts on a developer holder roller is a first vertical virtual plane and a vertical plane including the second abutting portion where the supply member cleaning blade abuts on the supply member is a second vertical virtual plane, the angle θ1 from the first virtual vertical plane to the lower surface of the developer holder cleaning blade in the vertical direction is smaller than the angle θ2 from the second virtual vertical plane to the lower surface of the supply member cleaning blade in the vertical direction.

In addition, a configuration may be employed in which the developer holder cleaning unit has a developer holder cleaning roller abutting on the developer holder roller, and the developer holder cleaning blade abuts on the developer holder cleaning roller.

In addition, a supply roller may be provided which has a groove on the peripheral surface and supplies the liquid developer to the supply member by abutting on the supply member.

In addition, the invention is not limited to the above-described embodiments, and various modifications besides the above described embodiments can be made without departing from the gist. For example, in the embodiment, the roller cleaning blade 512 and the inclined member 513 are arranged to be separated from each other. However, the inclined member 513 may be connected to the roller cleaning blade 512 so that the two are integrated with each other (second embodiment). In this case, the number of components and the number of mounting processes can be reduced, which is preferable in terms of cost and operation efficiency. In addition, in the first embodiment, there is a possibility that the liquid developer may be spattered when the liquid developer (waste liquid) recovered by the roller cleaning blade 512 drops onto the inclined member 513. However, according to the second embodiment, this can be prevented. In addition, a connection part between the roller cleaning blade 512 and the inclined member 513 may be provided with a curvature.

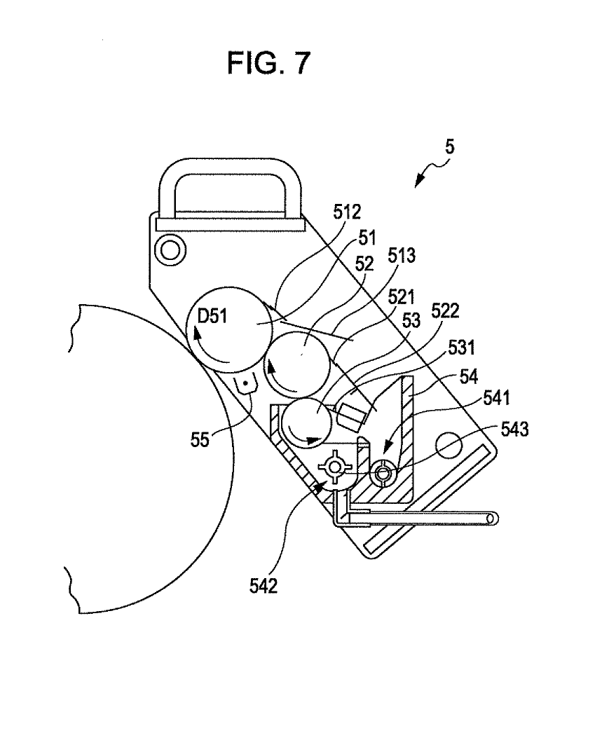

In addition in the embodiment, as a cleaning mechanism of the developing roller 51 (the “developer holder cleaning unit” of the invention), the cleaning roller 511 and the roller cleaning blade 512 are used. However, for example, as illustrated in FIG. 7, the cleaning blade 512 may be configured to directly abut on the developing roller 51 for cleaning (third embodiment). In addition, in the third embodiment, both the abutting angles θ1 and θ2 are set to 40°.

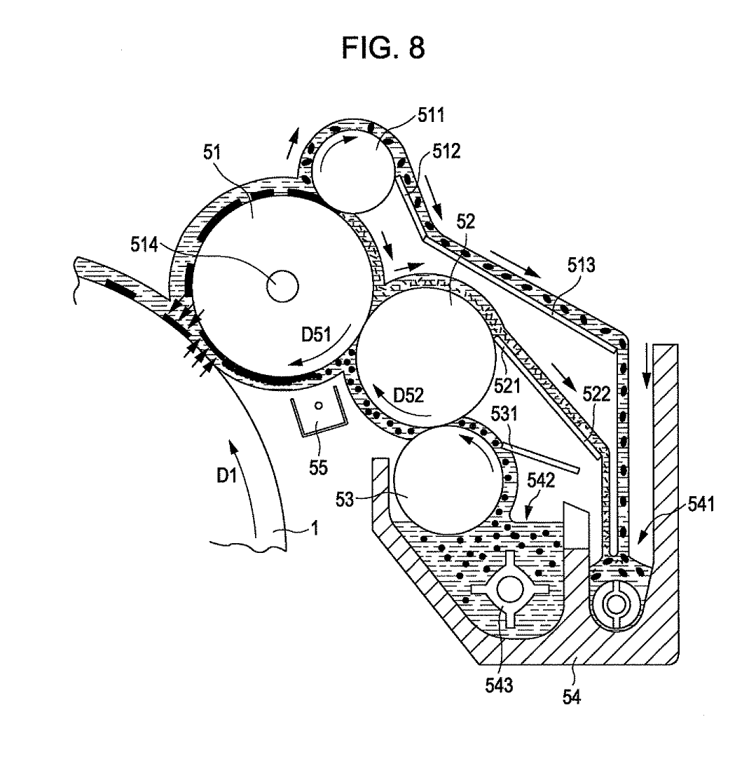

In addition, in the embodiment, the liquid developer (waste liquid) scraped by the roller cleaning blade 512 is transported to the upside of the recovery unit 541 of the developer container 54 in the vertical direction by the inclined members 513 and 522. However, for example, as illustrated in FIG. 8, the inclined member 513 may be configured to extend to the upside of the recovery unit 541 of the developer container 54 in the vertical direction so that the liquid developer scraped by the blade 512 directly falls into the recovery unit 541 from the inclined member 513 (fourth embodiment). In addition, in this case, the inclined member 522 guides only the liquid developer (waste liquid) scraped by the blade 521 to the upside of the recovery unit 541 of the developer container 54 in the vertical direction.

In addition, in the embodiment, a case where the invention is applied to the image forming apparatus having the so-called lower part transfer structure is described. However, the invention can also be applied to an image forming apparatus having a so-called upper part transfer structure in which an image held by the photoconductive drum 1 is transferred above a virtual horizontal plane HP passing through the rotation center of the photoconductive drum 1 in the vertical direction.

Next, examples of the invention will be described. However, of course, the invention is not limited by the examples described later, and can be implemented by appropriately adding modifications in a range suitable for the gist described above and later, and all the modifications belong to the technical scope of the invention.

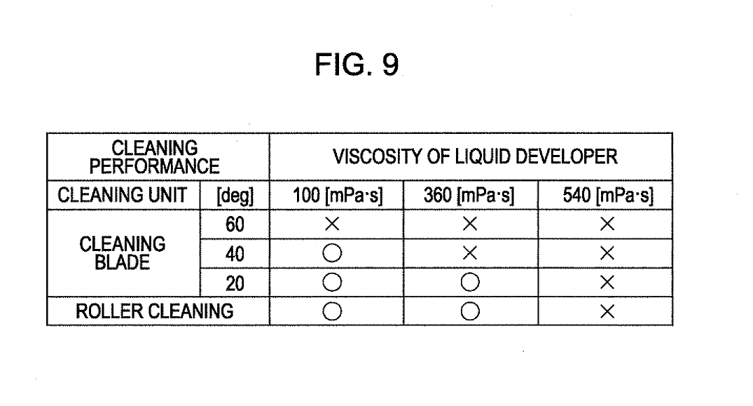

In the image forming apparatus described in the first embodiment, the abutting angle θ1 is set to 20°. This is based on the following experimental results. The experiment performed here verified cleaning performance when, as a cleaning unit for cleaning the developing roller, roller cleaning, a cleaning blade with an abutting angle of 20°, a cleaning blade with an abutting angle of 40°, and a cleaning blade with an abutting angle of 60° were used while liquid developers with various viscosities were used. Under each of such conditions, cleaning performance when continuous printing of 100,000 pages (A4 size) was performed with an image dot ratio of 25% was evaluated on the basis of whether or not defects such as vertical streaks were shown on the photoconductive drum. The evaluation results (◯: good, x: defective) are aggregated in FIG. 9. In addition, the amount of the cleaning roller stuck during roller cleaning was set to 0.2 mm, and the angle between the cleaning blade and the tangent line of the roller during blade cleaning and the amount of the stuck cleaning blade were set to 25° and 0.25 mm, respectively.

As apparent from FIG. 9, the cleaning performance is degraded as the viscosity of the liquid developer is increased, and is enhanced as the abutting angle of the cleaning blade approaches 0°, that is, the cleaning blade approaches to the vertical plane. In addition, regarding roller cleaning, even though a contact pressure is small, a liquid reservoir is less likely to be formed in the abutting portion of the cleaning roller, and cleaning performance substantially at the same level as that of the case where the cleaning blade with the abutting angle of 20° is used can be obtained.

Next, third and fourth embodiments of the invention will be described. Hitherto, an image forming apparatus of a liquid developing type in which an electrostatic latent image is formed on a charged photoconductor and the electrostatic latent image is developed by a liquid developer made by dispersing a toner in a carrier liquid thereby forming a toner image has been commercialized. For example, in a developing device employed by an image forming apparatus described in JP-A-2010-204399 (FIGS. 3 and 4), a supply developer storage unit that stores a liquid developer so as to be held by a developing roller and a recovery developer storage unit that recovers the liquid developer are provided in a developer container. In addition, in the developer container, two recovery openings are provided in a part of a wall portion that partitions the supply developer storage unit and the recovery developer storage unit, and the liquid developer on the supply developer storage unit side overflows via the recovery openings so as to be recovered by the recovery developer storage unit. Accordingly, the liquid surface level of the liquid developer in the supply developer storage unit is maintained at a constant level, so that the liquid developer can be uniformly supplied to the developing roller.

In addition, in the developing device, by transporting the liquid developer recovered by the recovery developer storage unit using a recovery screw in a predetermined direction, the recovered liquid developer is prevented from flowing backward to the supply developer storage unit via the recovery openings or overflowing from the developer container.

However, in the developing device, a developing roller cleaning unit abuts on the developing roller and cleans and removes the liquid developer after the developing process so as to be recovered by the recovery developer storage unit. Therefore, in order to prevent backflow and overflow of the liquid developer, as well as the liquid developer overflowing from the supply developer storage unit, the liquid developer recovered from the developer roller needs to be considered. However, according to the related art, this point is not sufficiently considered, so that there is a room for improvement.

An advantage of some aspects of the invention is that it provides a developing device capable of preventing a liquid developer recovered in a recovery unit from a storage unit and a developer holder roller from flowing backward to the storage unit and overflowing from the recovery unit, and an image forming apparatus including the developing device.

A developing device according to a third embodiment of the invention includes: a developer holder roller which holds a liquid developer containing a toner and a carrier liquid; a storage unit which stores the liquid developer supplied to a developer holder roller; a developer roller cleaning unit which cleans the developer holder roller and removes the liquid developer from the developer holder roller; a recovery unit which recovers the liquid developer removed from the developer holder roller by the developer holder cleaning unit; a partitioning member which has a flowing unit through which the liquid developer stored in the storage unit flows to the recovery unit and partitions the storage unit and the recovery unit; and a recovery path member which has a discharge unit which discharges the liquid developer to a position of the recovery unit that is different from that of the flowing unit in an axial direction of the developer holder roller, and recovers the liquid developer removed by the developer holder cleaning unit so as to flow to the recovery unit through the discharge unit.

An image forming apparatus according to a fourth embodiment of the invention includes: a latent image holder which holds a latent image; an exposure unit which exposes the latent image holder to form the latent image; and a developing unit which includes a developer holder roller which holds a liquid developer containing a toner and a carrier liquid, a storage unit which stores the liquid developer supplied to a developer holder roller, a developer roller cleaning unit which cleans the developer holder roller and removes the liquid developer from the developer holder roller, a recovery unit which recovers the liquid developer removed from the developer holder roller by the developer holder cleaning unit, a partitioning member which has a flowing unit through which the liquid developer stored in the storage unit flows to the recovery unit and partitions the storage unit and the recovery unit, and a recovery path member which has a discharge unit which discharges the liquid developer to a position of the recovery unit that is different from that of the flowing unit in an axial direction of the developer holder roller and recovers the liquid developer removed by the developer holder cleaning unit so as to flow to the recovery unit through the discharge unit.

In the embodiments of the invention (the developing device and the image forming apparatus) configured as described above, the liquid developer in the storage unit flows to the recovery unit via the flowing unit provided in the partitioning member, and the liquid developer removed by the developer holder cleaning unit also flows to the recovery unit. Therefore, when the liquid developer from the storage unit and the liquid developer removed by the developer holder cleaning unit flow together to the same position (recovery region) of the recovery unit, the liquid developer is present to be slanted toward the position, so that there may be cases where backflow of the liquid developer to the storage unit occurs at the corresponding position or overflow of the liquid developer from the recovery unit occurs. However, in the embodiments of the invention, the position where the liquid developer removed by the developer holder cleaning unit flows (recovery region) is different from the position where the liquid developer flows via the flowing unit, so that slanting of the liquid developer in the recovery unit can be prevented. As a result, problems in which the liquid developer recovered in the recovery unit from the storage unit and the developer holder roller flows backward to the storage unit or overflows from the recovery unit, and the like can be prevented.

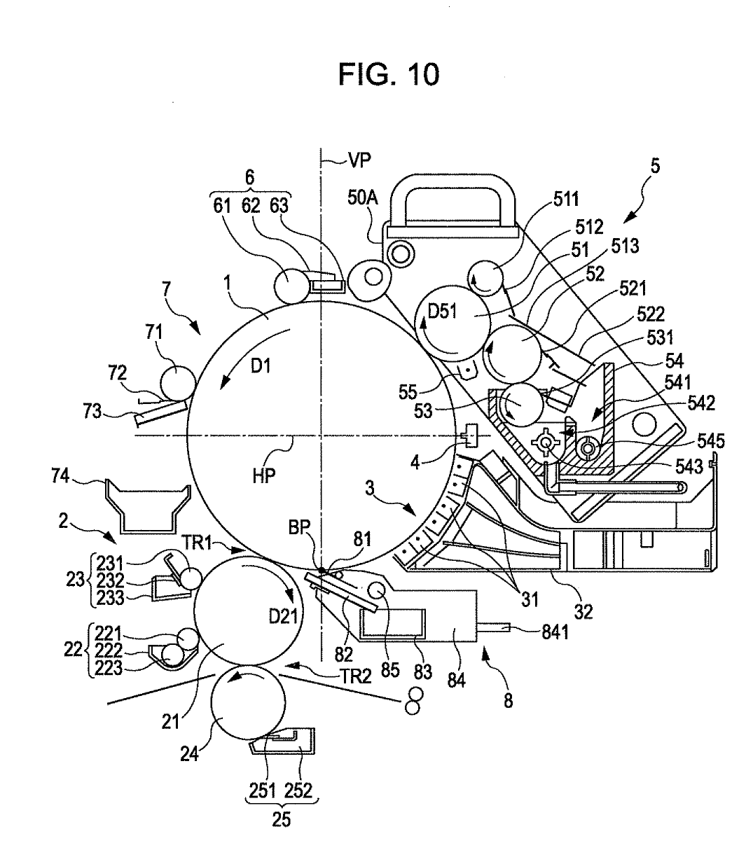

FIG. 10 is a diagram illustrating an image forming apparatus including a developing device according to a fifth embodiment of the invention. In the fifth embodiment, description which is common to the first embodiment will be omitted, and like elements are denoted by like reference numerals in FIG. 1 and detailed description thereof will be omitted.

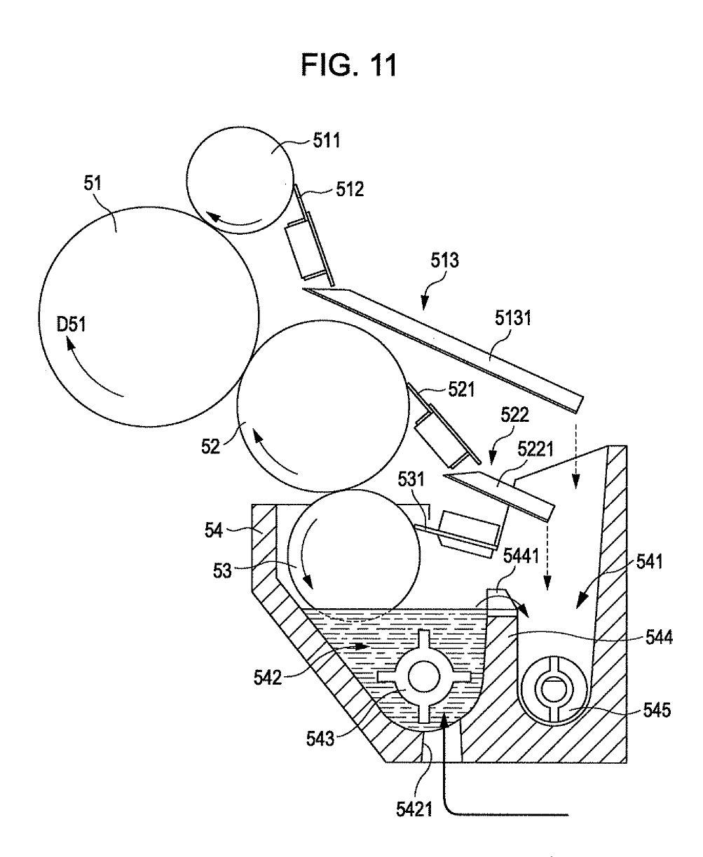

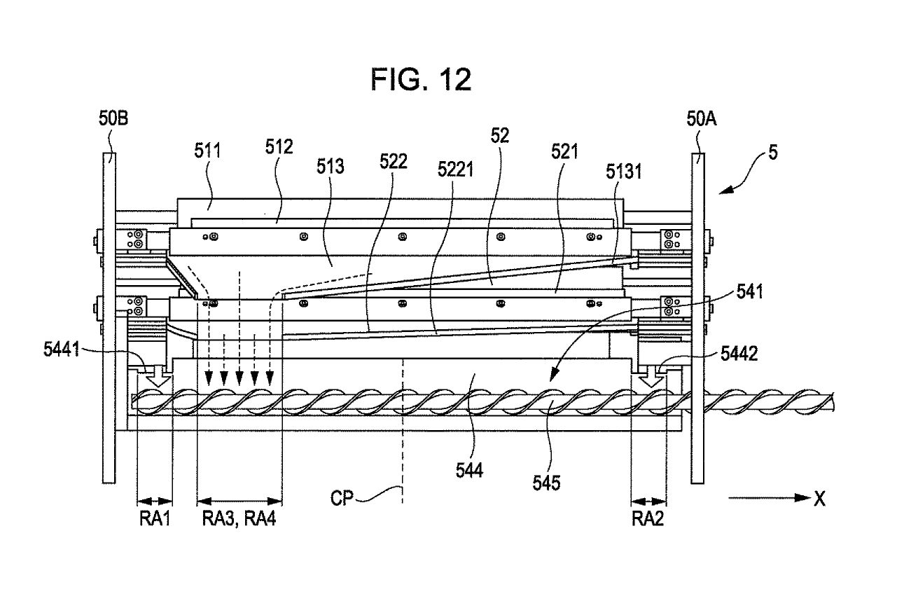

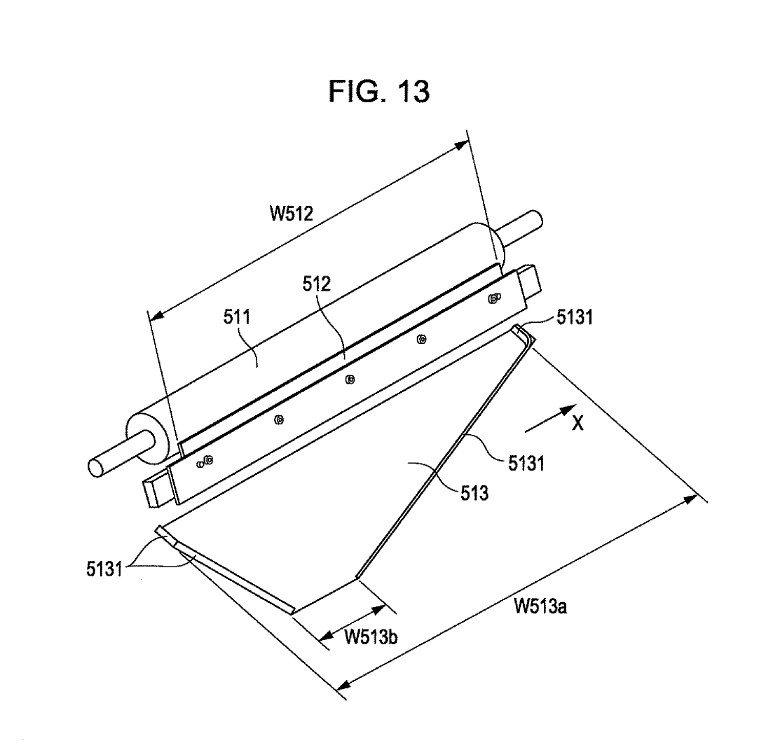

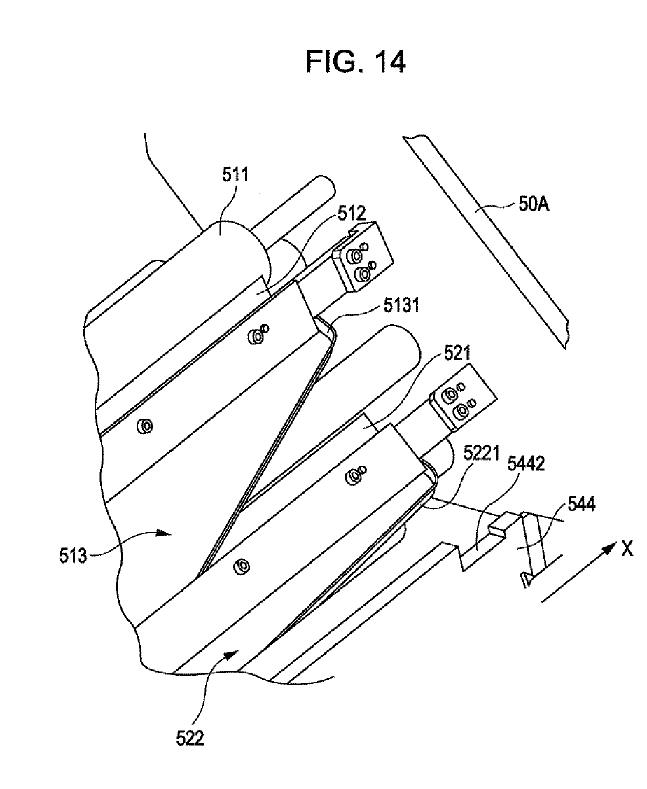

The configuration and the operation effects of a developing unit 5 will be described with reference to FIGS. 10 to 14. FIG. 11 is a diagram illustrating a developing unit which is the developing device according to the fifth embodiment of the invention. FIG. 12 is a diagram viewed from a side opposite to a photoconductive drum. FIG. 13 is a diagram illustrating a cleaning unit of a developing roller. FIG. 14 is a partially enlarged view of a recovery path member. As illustrated in FIGS. 10 and 11, the developing unit 5 has a so-called three-roller configuration including a developing roller 51, an intermediate application roller 52, and an anilox roller 53. Each of the rollers 51 to 53 is disposed so that the rotation axis is parallel to the rotation axis of the photoconductive drum 1 and both end portions are axially supported by a pair of side plates 50A and 50B so as to be rotatable.

In this embodiment, a developer holder cleaning unit is provided in order to clean and remove the liquid developer from the developing roller 51. The developer holder cleaning unit has a cleaning roller 511 and a roller cleaning blade 512. The cleaning roller 511 abuts on the developing roller 51 and the roller cleaning blade 512 abuts on the cleaning roller 511 so as to perform a cleaning process of the developing roller 51. More specifically, the cleaning roller 511 abuts on the surface of the developing roller on the downstream side of the rotation direction D51 of the developing roller 51 with respect to a development position where the surface of the developing roller 51 abuts on the photoconductive drum 1 and thus forms a development nip, and is rotated clockwise in FIGS. 10 and 11. Therefore, the cleaning roller 511 is rotated in the counter direction to the developing roller 51, and thus does not contribute to development and removes the liquid developer remaining on the developing roller 51. In addition, the roller cleaning blade 512 abuts on the surface of the cleaning roller 511 so as to scrape off and remove the liquid developer.

An inclined member 513 is disposed below the roller cleaning blade 512 in the vertical direction and above the intermediate application roller 52 in the vertical direction. An end portion of the inclined member 513 on the developing roller side (on the left of FIG. 11) is higher than an end portion thereof on the opposite side to the developing roller (on the right of FIG. 11) and the inclined member 513 is inclined downward in the vertical direction as it goes from the developing roller 51 and extends to the upside of a recovery unit 541 of a developer container 54. In addition, the inclined member 513 is fixed to side plates 50A and 50B so that the end portion thereof on the developing roller side is positioned below the roller cleaning blade 512 in the vertical direction. In this embodiment, as illustrated in FIG. 13, the length W513a in the rotation axis direction X of the end portion of the inclined member 513 on the developing roller side is greater than the length W512 in the rotation axis direction X of the roller cleaning blade 512, that is,

### W513a>W512.

In the inclined member 513, as illustrated in FIGS. 12 and 13, side fences (wall portions) 5131 are erected upward in the vertical direction at both end sides in the width direction X. In addition, each of the side fences 5131 extends toward the end portion of the inclined member 513 on the side opposite to the developing roller (lower right side of FIG. 13) so as to guide the liquid developer (waste liquid) to the upside of the recovery unit 541 in the vertical direction. In addition, the liquid developer recovered from the position drops onto the recovery unit 541 from the end portion of the inclined member 513 on the side opposite to the developing roller. Therefore, the inclined member 513 receives all the liquid developer (waste liquid) recovered by the roller cleaning blade 512 so as to flow to the recovery unit 541 of the developer container 54. As such, in this embodiment, the inclined member 513 functions as a “recovery path member” of the invention, and the end portion of the inclined member 513 on the side opposite to the developing roller corresponds to a “discharge unit” of the invention.

Moreover, as illustrated in FIG. 13, the interval between both the side fences 5131 in the width direction X is narrowed toward the side opposite to the developing roller (lower right side of the same figure), and a length W513b in the rotation axis direction X of the end portion on the side opposite to the developing roller becomes narrower than a length W513a in the rotation axis direction X of the end portion on the developing roller side. Moreover, as illustrated in FIG. 12, the end portion of the inclined member 513 on the side opposite to the developing roller is positioned further towards the upstream side than the center portion in the transportation direction X of the liquid developer in the recovery unit 541. In addition, this point will be described later.

In addition, the cleaning blade 521 abuts on the intermediate application roller 52 and thus scrapes off and removes the liquid developer that does not contribute to development and remains on the intermediate application roller 52 from the surface of the intermediate application roller 52. As described above, in this embodiment, the intermediate application roller 52 and the cleaning blade 521 respectively function as a “supply member” and a “supply member cleaning unit” of the invention.

An inclined member 522 is disposed below the cleaning blade 521 in the vertical direction. Similarly to the inclined member 513, an end portion of the inclined member 522 on the intermediate application roller side (on the left of FIG. 11) is higher than an end portion thereof on the opposite side to the intermediate application roller (on the right of FIG. 11) and the inclined member 522 is inclined downward in the vertical direction as it goes from the intermediate application roller 52 and extends to the upside of the recovery unit 541 of the developer container 54. In addition, the inclined member 522 is fixed to the side plates 50A and 50B so that the end portion thereof on the intermediate application roller side is positioned below the cleaning blade 521 in the vertical direction. In this embodiment, although illustration is omitted, the length in the rotation axis direction X of the end portion of the inclined member 522 on the intermediate application roller side is greater than the length in the rotation axis direction X of the cleaning blade 521.

In the inclined member 522, as illustrated in FIG. 12, side fences (wall portions) 5221 are erected upward in the vertical direction at both end sides in the width direction X. In addition, each of the side fences 5221 extends toward the end portion of the inclined member 522 on the side opposite to the intermediate application roller so as to guide the liquid developer (waste liquid) to the upside of the recovery unit 541 in the vertical direction from the end portion of the inclined member 522 on the side opposite to the intermediate application roller. In addition, the liquid developer recovered from the position drops onto the recovery unit 541. Therefore, the inclined member 522 receives all the liquid developer (waste liquid) recovered by the cleaning blade 521 so as to flow to the recovery unit 541 of the developer container 54. As such, in this embodiment, the inclined member 522 functions as a “second recovery path member” of the invention, and the end portion of the inclined member 522 on the side opposite to the intermediate application roller corresponds to a “second discharge unit” of the invention.

Moreover, the interval between both the side fences 5221 in the width direction X is narrowed toward the side opposite to the intermediate application roller, and the length in the rotation axis direction X of the end portion on the side opposite to the intermediate application roller becomes narrower than the length in the rotation axis direction X of the end portion on the intermediate application roller side. Moreover, as illustrated in FIG. 12, the end portion of the inclined member 522 on the side opposite to the developing roller is positioned further towards the upstream side than the center portion in the transportation direction X of the liquid developer in the recovery unit 541. In addition, this point will also be described later.

On the other hand, a restriction member 531 abuts on the anilox roller 53. As the restriction member 531, a member made of metal or a member having elasticity which is configured by coating an elastic body on the surface may be used. The restriction member 531 according to this embodiment is configured of a rubber portion made of urethane rubber or the like abutting on the surface of the anilox roller 53 and a plate made of metal or the like for supporting the rubber portion. In addition, the restriction member 531 has functions of restricting and adjusting the thickness, the amount, and the like of the liquid developer held and transported by the anilox roller 53 thereby adjusting the amount of the liquid developer supplied to the developing roller 51. In addition, the liquid developer scraped by the restriction member 531 is returned to a storage unit 542 of the developer container 54. An agitating member 543 is disposed in the storage unit 542 and is rotated by a motor of which illustration is omitted so as to agitate the liquid developer in the storage unit 542.

The storage unit 542 of the developer container 54 has the function of storing the liquid developer to be supplied to the developing roller 51 via the anilox roller 53 and the intermediate application roller 52 as described above, and as illustrated in FIG. 11, a liquid developer of which the concentration is adjusted is appropriately supplied to the storage unit 542 through supply holes 5421 provided at the center portion of the bottom surface of the storage unit 542. In addition, in the storage unit 542, the liquid developer is agitated by rotation of the agitating member 543 and is transported in the axial direction X thereof. In this embodiment, the transportation directions of the agitating member 543 are different with respect to the supply holes 5421 as boundaries, and the liquid developer flowing through the supply holes 5421 is divided to be transported to a front side and a rear side in the same figure.

In the developer container 54, a partitioning member 544 that partitions the recovery unit 541 and the storage unit 542 extends in the axial direction X. At both end portions of the partitioning member 544 in the axial direction X, as illustrated in FIG. 12, a first flowing opening 5441 and a second flowing opening 5442 are provided by partially cutting off the upper end of the partitioning member 544, so that the liquid developer transported into the storage unit 542 by the agitating member 543 overflows through the flowing openings 5441 and 5442 and flows to first and second recovery regions RA1 and RA2 of the recovery unit 541. As described above, an overflow structure is employed in which the storage unit 542 communicates with the recovery regions RA1 and RA2 of the recovery unit 541 through the flowing openings 5441 and 5442 and the liquid developer flows from the storage unit 542 to the recovery unit 541. Accordingly, the liquid surface level of the liquid developer in the storage unit 542 is maintained at a constant level, so that the liquid developer can be uniformly supplied to the developing roller 51 via the anilox roller 53 and the intermediate application roller 52. As described above, in this embodiment, the flowing openings 5441 and 5442 of the partitioning member 544 constitute a “flowing unit” of the invention.

As such, the liquid developer overflowing from the storage unit 542 and the liquid developer that is cleaned, removed, and recovered flow into the recovery unit 541. In addition, the liquid developer is transported in a direction X parallel to the rotation axis direction X of the developing roller 51 by an auger (recovery screw) 545 disposed in the recovery unit 541 so as to flow out from a transportation hole (not shown) that is open at the side surface of the recovery unit 541. As such, in this embodiment, the auger 545 functions as a “transportation member” of the invention.

Here, regarding flow positions of the liquid developer in the recovery unit 541, that is, recovery regions, in this embodiment, positions through which the liquid developer (outline arrows in the same figure) overflowing from the flowing openings 5441 and 5442 flows, that is, the recovery regions RA1 and RA2 of the recovery unit 541 that recovers the liquid developer are different from positions through which the liquid developer (dotted line arrows in the same figure) dropping from the inclined members 513 and 522 flows, that is, recovery regions RA3 and RA4 of the recovery unit 541 that recovers the liquid developer. Therefore, concentration of the liquid developer in the recovery regions RA1 and RA2 can be prevented, and backflow of the liquid developer recovered in the recovery unit 541 to the storage unit 542 via the flow openings 5441 and 5442 can be prevented. In addition, the liquid developer can be prevented from overflowing from the developer container 54 to the recovery regions RA1 and RA2 and contaminating peripheral devices of the developing unit 5.

Causing the recovery regions RA3 and RA4 to be different from the recovery regions RA1 and RA2 is advantageous in the following point. That is, even though the recovery regions RA3 and RA4 overlap with the recovery regions RA1 and RA2, as a measure so as not to cause this problem, for example, optimizing transportation characteristics of the auger 545 may be considered. However, in this case, a screw shape needs to be designed and optimized for each toner. Even when optimization is achieved, the liquid developer dropping from the inclined members 513 and 522 is so-called waste liquid, and the agglutinated state of the toner in the liquid developer is changed during continuous use, so that the transportation amount of the liquid developer becomes unstable and the problem occurs. On the contrary, in this embodiment, by causing the recovery regions RA3 and RA4 to be different from the recovery regions RA1 and RA2, a slant of the liquid developer in the recovery unit 541 is reduced, so that backflow, overflow, and the like can be effectively prevented.

In addition, in this embodiment, the liquid developer in the recovery unit 541 is transported in the direction X (from the left to the right of FIG. 12) by the auger 545, and the second flowing opening 5442 is provided to be distant from the first flowing opening 5441 in the transportation direction X. That is, the first flowing opening 5441 is disposed on the upstream side of the second flowing opening 5442 in the transportation direction X, the first recovery region RA1 is disposed on the upstream side of the second recovery region RA2 in the transportation direction X, and the auger 545 transports the recovered liquid developer recovered from the first flowing opening 5441 to the second flowing opening 5442 side. On the other hand, as illustrated in FIG. 12, both the recovery regions RA3 and RA4 are positioned between the center position CP between the first and second recovery regions RA1 and RA2 and the first recovery region RA1. That is, the end portion of the inclined member 513 on the side opposite to the developing roller (discharge unit) and the end portion of the inclined member 522 on the side opposite to the intermediate application roller (second discharge unit) is positioned on the first flowing opening 5441 side in the transportation direction X and causes the liquid developer to flow. Therefore, a slant of the liquid developer in the recovery unit 541 can be effectively prevented.

As described above, a configuration may be employed in which the transportation member which is disposed in the recovery unit and transports the liquid developer stored in the recovery unit in the axial direction of the developer holder roller is provided, the flowing unit of the partitioning member includes the first flowing opening disposed on the one end portion side in the axial direction of the developer holder roller and the second flowing opening disposed on the other end portion side in the opposite direction to the one end portion side in the axial direction of the developer holder roller, and the discharge unit of the recovery path member causes the liquid developer to flow at a position between the first and second flowing openings in the axial direction of the developer holder roller.

In addition, a configuration may be employed in which the transportation member transports the liquid developer stored in the recovery unit from the first flowing opening side to the second flowing opening side, and the discharge unit of the recovery path member causes the liquid developer to flow to the position on the first flowing opening side in the axial direction of the developer holder roller.

In addition, the supply member which supplies the liquid developer stored in the storage unit to the developer holder roller, the supply member cleaning unit which cleans the supply member and removes the liquid developer from the supply member, the second recovery path member which has the second discharge unit which discharges the liquid developer to a position of the recovery unit that is different from that of the flowing unit in an axial direction of the developer holder roller and causes the liquid developer removed by the supply member cleaning unit to flow to the recovery unit through the second discharge unit may be included.

In addition, a configuration may be employed in which the width of the second discharge unit in the axial direction of the developer holder roller is greater than the width of the first discharge unit in the axial direction of the developer holder roller.

In addition, a configuration may be employed in which the position of an end portion of the second discharge unit on the second flowing opening side is positioned further towards the second flowing opening side than the position of an end portion of the discharge unit on the second flowing opening side.

Moreover, a configuration may be employed in which the developer holder cleaning unit has the developer holder cleaning blade which abuts on the developer holder roller, and the recovery path member supports the developer holder cleaning blade.

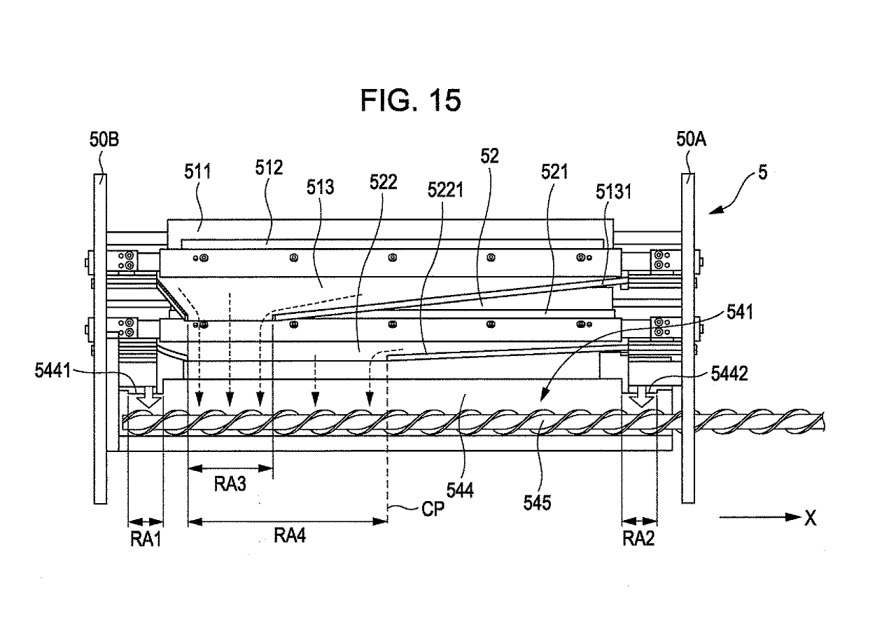

The invention is not limited to the above-described embodiments, and various modifications besides the above described embodiments can be made without departing from the gist. For example, in the fifth embodiment, the third recovery region RA3 to which the liquid developer flows from the inclined member 513 is configured to be aligned with the fourth recovery region RA4 to which the liquid developer flows from the inclined member 522. That is, the end portion of the inclined member 522 on the side opposite to the intermediate application roller is positioned below the end portion of the inclined member 513 on the side opposite to the developing roller in the vertical direction and the widths of the two in the rotation axis direction X are equal to each other. Here, in many cases, the amount of the liquid developer recovered from the developing roller 51 is greater than the amount of the liquid developer recovered from the intermediate application roller 52. Consequently, as illustrated in FIG. 15, the width of the end portion of the inclined member 522 on the side opposite to the intermediate application roller may be increased (sixth embodiment). In the sixth embodiment, an end portion of the fourth recovery region RA4 on the downstream side in the transportation direction X is positioned further towards the downstream side in the transportation direction X than the third recovery region RA3 (on the right in the same figure). That is, the position on the second flowing opening 5442 side of the end portion (the second discharge unit) of the inclined member 522 on the side opposite to the intermediate application roller is positioned further towards the second flowing opening 5442 side than the position on the second flowing opening 5442 side of the end portion (the discharge unit) of the inclined member 513 on the side opposite to the developing roller, so that the amount of the liquid developer in the recovery unit 541 in the transportation direction X can be averaged. In addition, in the sixth embodiment, as illustrated in FIG. 15, the fourth recovery region RA4 is aligned with the third recovery region RA3 on the upstream side of the transportation direction (on the left in the same figure), and may also be configured to be shifted to the downstream side of the transportation direction (on the right of the same figure).

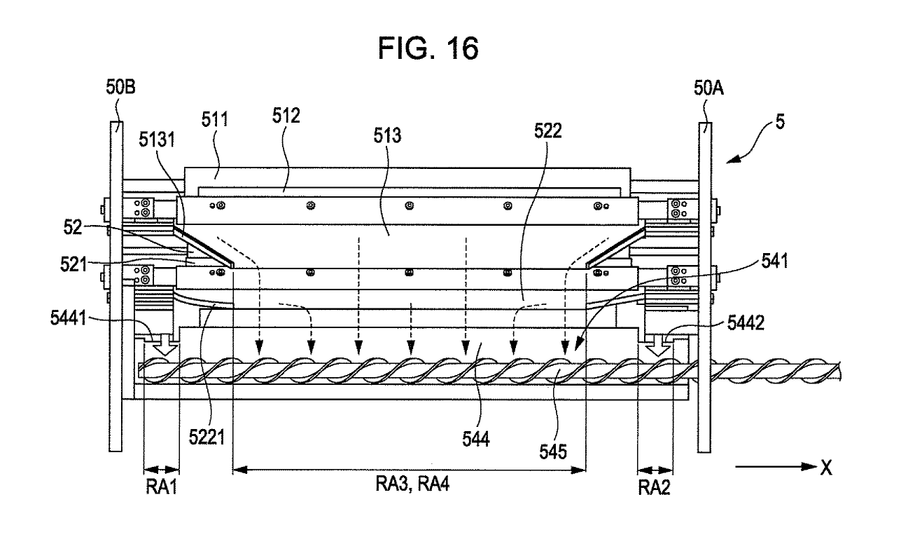

In addition, in the above-described embodiments, the third and fourth recovery regions RA3 and RA4 are positioned further towards the upstream side in the transportation direction X than the center position CP between the first and second recovery positions RA1 and RA2. However, the positions of the third and fourth recovery regions RA3 and RA4 are not limited to this as long as they are between the first and second recovery regions RA1 and RA2. For example, as illustrated in FIG. 16, the third and fourth recovery regions RA3 and RA4 are disposed at the center between the first and second recovery regions RA1 and RA2. That is, the end portion (the discharge unit) of the inclined member 513 on the side opposite to the developing roller and the end portion of the inclined member 522 on the side opposite to the intermediate application roller (the second discharge unit) may be configured to be disposed at the center between the flowing openings 5441 and 5442 (seventh embodiment).

In addition, in the above-described embodiments, the cleaning roller 511 and the roller cleaning blade 512 are used as the cleaning unit of the developing roller 51. However, the configuration of the developer holder cleaning unit is not limited to this, and for example, the invention can also be applied to a developing device which causes the cleaning blade 512 to directly abut on and clean the developing roller 51. In this case, the cleaning blade 512 may be configured to support the inclined member 513 which is the recovery path member.

In addition, in the above-described embodiments, the invention is applied to the developing unit 5 having the so-called three-roller configuration. However, an object to which the invention is applied is not limited to this, and the invention can also be applied to a developing device having a configuration in which the liquid developer is directly applied to the developing roller 51 from the anilox roller 53 (two-roller configuration).

Moreover, in the above-described embodiments, the case where the invention is applied to the image forming apparatus having a so-called low part transfer structure will be described. However, an object to which the invention is applied is not limited to this, and for example, the invention can also be applied to an image forming apparatus having a so-called upper part transfer structure in which an image held by the photoconductive drum 1 is transferred above the virtual horizontal plane HP passing through the rotation center of the photoconductive drum 1 in the vertical direction.

Next, the fifth and sixth embodiments of the invention will be described. Hitherto, an image forming apparatus of a liquid developing type in which an electrostatic latent image is formed on a charged photoconductor and the electrostatic latent image is developed by a liquid developer made by dispersing a toner in a carrier liquid thereby forming a toner image has been commercialized. For example, in an image forming apparatus described in JP-A-2010-185984 (FIG. 5), a liquid developer is supplied to a developing roller via an intermediate roller (supply roller) so as to be held by the developing roller. In addition, a latent image on the surface of a photoconductive drum is developed by the liquid developer on the developing roller, and thereafter the liquid developer remaining on the developing roller after passing through a development position is scraped by a cleaner blade of the developing roller.

However, in the developing device using the liquid developer, in order to increase developing efficiency, a charger for applying a voltage is provided to drive toner contained in the liquid developer held on the developing roller before a developing process out of the surface of the developing roller so as to be agglutinated and compressed. Therefore, the liquid developer remaining on the surface of the developing roller after the developing process contains the compressed toner, and thus the flowability of the liquid developer is poor. Furthermore, there may be cases where even though the liquid developer is scraped by the cleaner blade, the liquid developer is deposited on the front end portion of the cleaner blade, so that it is difficult to flow and recover the liquid developer in the recovery unit properly. In this case, the deposited liquid developer flows to both end portions of the cleaner blade in the width direction and contaminates the inside of the developing device. This point is not sufficiently considered in an apparatus according to the related art.

In addition, the image forming apparatus described in JP-A-2010-185984 as above employs the so-called upper part transfer structure in which a toner image held by the photoconductive drum is transferred onto a transfer medium above the virtual horizontal plane passing through the rotation center of the photoconductive drum in the vertical direction. However, this problem also occurs in, for example, an image forming apparatus that employs the lower part transfer structure as described in JP-A-2009-282280 (FIG. 1). In the apparatus described in JP-A-2009-282280, this point is not considered at all, and a specific configuration for recovering the liquid developer scraped by the cleaner blade is not described.

An advantage of some aspects of the invention is that it provides a technique for, in a developing device which performs development using a liquid developer containing a toner compressed on a developer holder and an image forming apparatus including the developing device, causing the liquid developer scraped by a cleaning blade to properly flow from the front end of the cleaning blade thereby preventing the liquid developer from being deposited on the front end of the cleaning blade.

The developing device according to the fifth embodiment of the invention includes: a developer holder roller which holds a liquid developer containing a toner and a carrier liquid and rotates about a rotation axis; a toner charging unit which charges the toner contained in the liquid developer held by the developer holder roller; a developer holder cleaning roller which abuts on the developer holder roller on a second side opposite to a first side of a second virtual vertical plane passing through a position where a virtual horizontal plane that is perpendicular to a first virtual vertical plane passing through the rotation axis of the developer holder roller intersects a peripheral surface of the developer holder roller on a first side of the first virtual vertical plane, and cleans the liquid developer containing the toner charged by the toner charging unit so as to remove the liquid developer from the developer holder roller; and a developer holder cleaning blade which abuts on the developer holder cleaning roller on the first side of the second virtual vertical plane and cleans the developer holder cleaning roller.

The image forming apparatus according to the sixth embodiment of the invention includes: a latent image holder on which a latent image is formed; and a developing unit including a developer holder roller which holds a liquid developer containing a toner and a carrier liquid and rotates about a rotation axis, a toner charging unit which charges the toner contained in the liquid developer held by the developer holder roller, a developer holder cleaning roller which abuts on the developer holder roller on a second side opposite to a first side of a second virtual vertical plane passing through a position where a virtual horizontal plane that is perpendicular to a first virtual vertical plane passing through the rotation axis of the developer holder roller intersects a peripheral surface of the developer holder roller on a first side of the first virtual vertical plane and cleans the liquid developer containing the toner charged by the toner charging unit so as to remove the liquid developer from the developer holder roller, and a developer holder cleaning blade which abuts on the developer holder cleaning roller on the first side of the second virtual vertical plane and cleans the developer holder cleaning roller, and forming the latent image formed on the latent image holder.

In the embodiments of the invention (the developing device and the image forming apparatus) configured as described above, the toner contained in the liquid developer held by the developer holder roller is cleaned while being agglutinated, flowability of the liquid developer at a cleaning position is poor. Therefore, the liquid developer is more likely to be deposited on the front end of the developer holder cleaning blade. However, as described later, by reducing an angle between the developer blade cleaning blade and the virtual vertical plane, that is, a so-called blade angle, due to the influence of gravity on the liquid developer deposited on the developer holder cleaning blade, the liquid developer easily flows down in the vertical direction. Consequently, in the embodiment of the invention, after the liquid developer is removed from the developer holder roller by the developer holder cleaning roller, the liquid developer is cleaned from the developer holder cleaning roller by the developer holder cleaning blade. Moreover, the developer holder cleaning roller abuts on the developer holder roller on the second side opposite the a first side of the second virtual vertical plane passing through the position where the virtual horizontal plane that is perpendicular to the first virtual vertical plane passing through the rotation axis of the developer holder roller intersects the peripheral surface of the developer holder roller on the first side of the first virtual vertical plane, and the developer holder cleaning blade abuts on the developer holder cleaning roller on the first side of the second virtual vertical plane so as to clean the developer holder cleaning roller. Therefore, the blade angle can be reduced, and thus the liquid developer scraped by the developer holder cleaning blade can be caused to flow down in the vertical direction by gravity. As a result, the liquid developer can be prevented from being deposited on the front end of the developer holder cleaning blade.

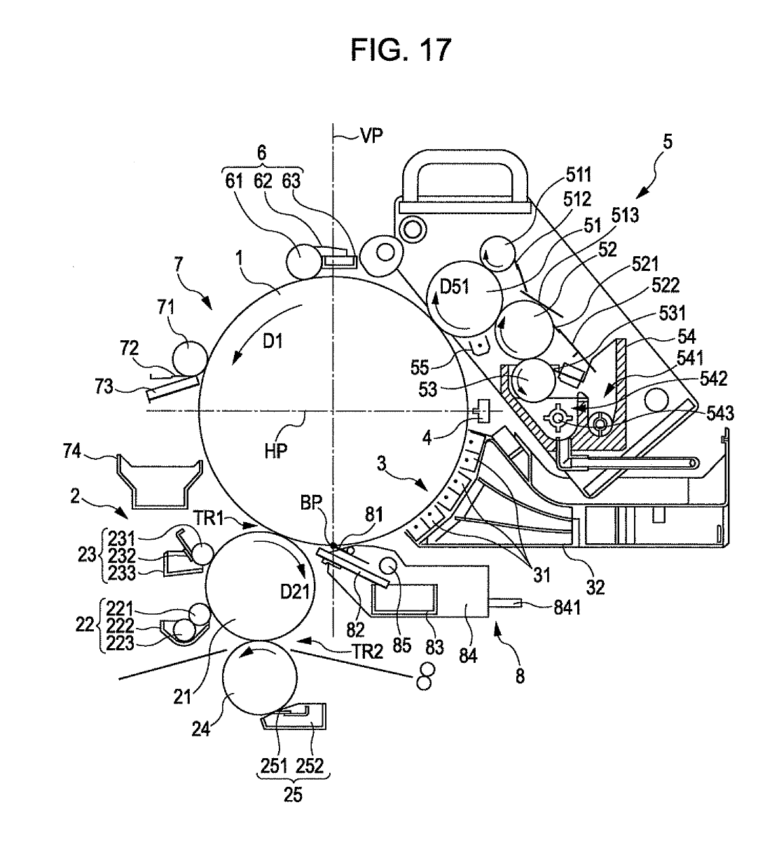

FIG. 17 is a diagram illustrating an image forming apparatus including a developing device according to an eighth embodiment of the invention. In the eighth embodiment, description which is common to the first embodiment will be omitted, and like elements are denoted by like reference numerals in FIG. 1 and detailed description thereof will be omitted.

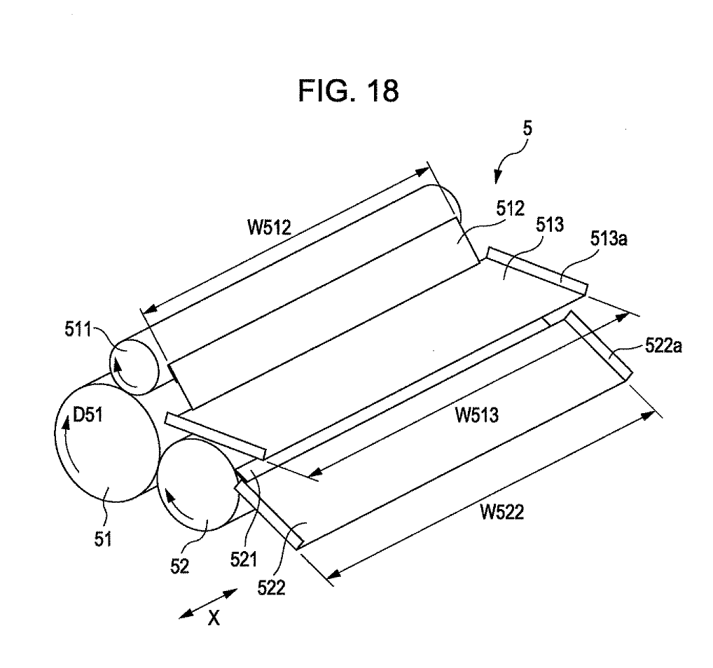

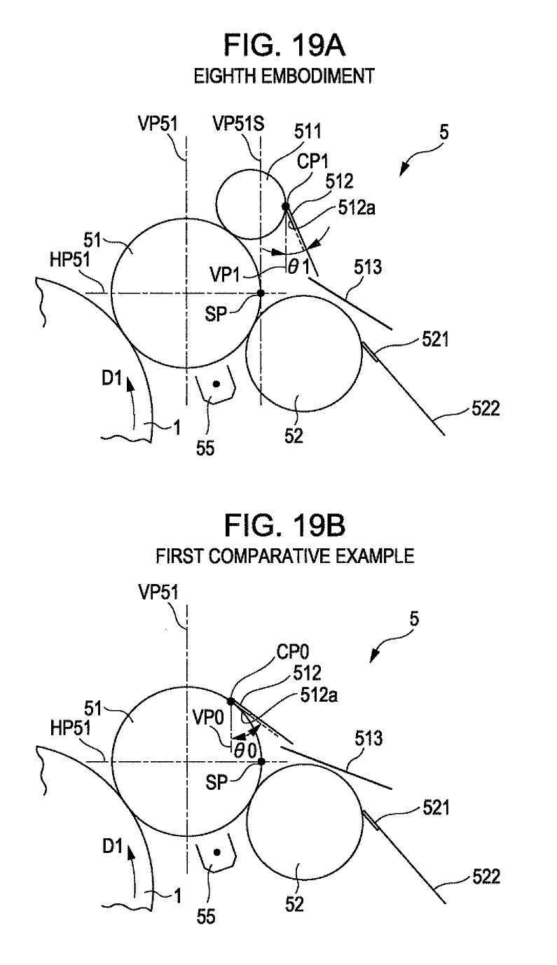

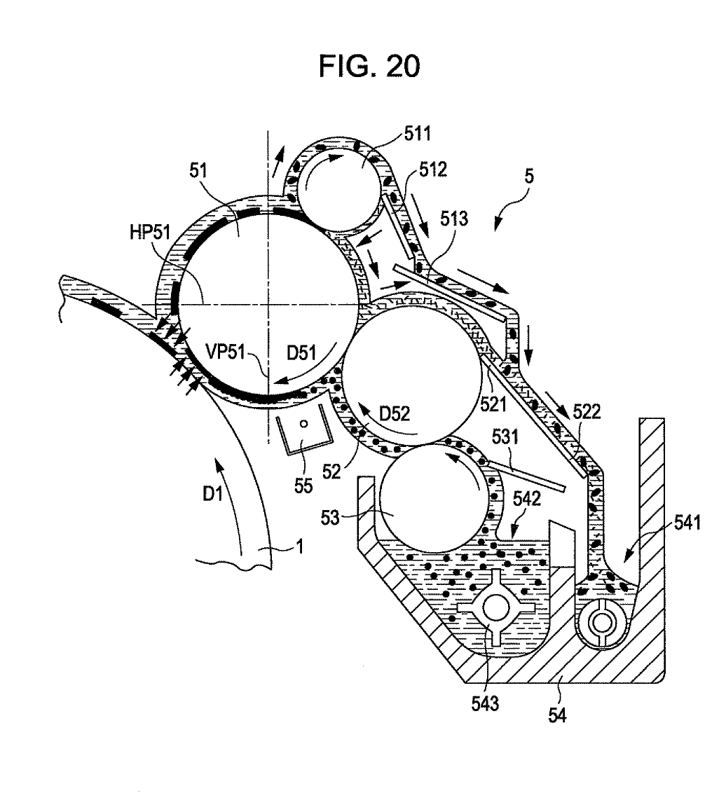

The configuration and the operation effects of a developing unit 5 will be described with reference to FIGS. 17 to 20. FIG. 18 is a perspective view illustrating an overall configuration of a cleaning mechanism of a developing roller and an intermediate application roller. FIGS. 19A and 19B are diagrams illustrating abutting angles of a developing roller cleaning blade and an intermediate application roller cleaning blade. FIG. 20 is a schematic diagram illustrating a recovery path of a waste liquid recovered by the cleaning mechanism.

As illustrated in FIGS. 17 to 20, the developing unit 5 has a so-called three-roller configuration including a developing roller 51, an intermediate application roller 52, and an anilox roller 53. Each of the rollers 51 to 53 is disposed so that the rotation axis is parallel to the rotation axis of a photoconductive drum 1 and both end portions are axially supported by a pair of side plates of which illustration is omitted, so as to be rotatable. More specifically, each of the rollers 51 to 53 is configured as follows.

The developing roller 51 is a cylindrical member and is made by providing an elastic layer such as polyurethane rubber, silicon rubber, or an NBR or PFA tube on the outer peripheral portion of an inner core made of a metal such as iron. The developing roller 51 is disposed on the right with respect to a virtual vertical plane VP in FIG. 17 and above a virtual horizontal plane HP in the vertical direction, and as illustrated in FIG. 19A, abuts on the photoconductive drum 1 on the left in the same figure with respect to a virtual vertical plane VP51 passing through the rotation center of the developing roller 51 below a virtual horizontal plane HP51 passing through the rotation center of the developing roller 51, in the vertical direction. The developing roller 51 is connected to a developing motor (not shown) and is driven to rotate clockwise D51 in FIG. 17 so as to rotate along with the photoconductive drum 1. In addition, the developing roller 51 is electrically connected to a developing bias generation unit of which illustration is omitted so that a developing bias is applied to the developing roller 51 at an appropriate timing. Accordingly, a latent image held by the photoconductive drum 1 is developed.

In addition, in order to supply the liquid developer to the developing roller 51, the intermediate application roller 52 and the anilox roller 53 are provided, and the liquid developer is supplied to the developing roller 51 from the anilox roller 53 via the intermediate application roller 52. Of the rollers, the intermediate application roller 52 is made by providing an elastic layer on the outer peripheral portion of an inner core made of metal similarly to the developing roller 51, and as illustrated in FIG. 19A, abuts on the developing roller 51 on a site opposite to the photoconductive drum with respect to the virtual vertical plane VP51 (on the right in the same figure) and below the virtual horizontal plane HP51 passing through the rotation center of the developing roller 51 in the vertical direction so as to supply the liquid developer. As described above, in this embodiment, the intermediate application roller 52 corresponds to a “supply member” of the invention.

On the other hand, the anilox roller 53 is a roller in which a concave pattern is formed of spiral grooves or the like carved finely and uniformly on the surface so as to easily hold the liquid developer. Of course, similarly to the developing roller 51 or the intermediate application roller 52, the anilox roller 53 may use one made by winding a rubber layer such as urethane or NBR or coating a PFA tube around a metal core.

The intermediate application roller 52 and the anilox roller 53 are connected to the developing motor and are rotated clockwise and counterclockwise in FIG. 17, respectively. Therefore, the intermediate roller 52 is rotated in the counter direction to the developing roller 51, and the anilox roller 53 is rotated along with the intermediate application roller 52. As described above, in this embodiment, since the liquid developer is supplied to the developing roller 51 from a developer container 54 by the so-called three-roller configuration, as the liquid developer passes through the nips a plurality of times, the liquid developer can be kneaded, and thus a uniform liquid developer film can be formed on the developing roller 51.

Next, the cleaning mechanism of the developing roller and the intermediate application roller will be described. A cleaning roller 511 abuts on the developing roller 51, and a roller cleaning blade 512 abuts on the cleaning roller 511 so as to perform a cleaning process on the developing roller 51. More specifically, as illustrated in FIGS. 19A and 19B, the cleaning roller 511 abuts on the developing roller 51 on the side opposite to photoconductive drum (on the right in the same figure) with respect to the virtual vertical plane VP51 and above the virtual horizontal plane HP51 in the vertical direction, in a posture in which a part of the peripheral surface of the cleaning roller 511 crosses a virtual vertical plane VP51S passing through a position SP on the side opposite to the photoconductive drum where the virtual horizontal plane HP51 intersects the peripheral surface of the developing roller 51, toward the side opposite to the developing roller (on the right in the same figure). This abutting position is on the downstream side of the rotation direction D51 of the developing roller 51 with respect to a development position where the surface of the developing roller 51 abuts on the photoconductive drum 1 so as to form a development nip. In addition, the cleaning roller 511 is rotated clockwise in FIGS. 17, 19A and 19B, and 20 while abutting on the surface of the developing roller 51. Therefore, the cleaning roller 511 is rotated in the counter direction to the developing roller 51, and thus does not contribute to development and removes the liquid developer remaining on the developing roller 51.

In this embodiment, on the side opposite to the developing roller with respect to the virtual vertical plane VP51S (on the right in FIGS. 19A and 19B), the roller cleaning blade 512 abuts on the surface of the cleaning roller 511 at an abutting angle θ1 (blade angle) to scrape off and remove the liquid developer. That is, an angle between the vertical virtual plane VP1 extending downward in the vertical direction from an abutting portion CP1 where the roller cleaning blade 512 abuts on the cleaning roller 511 and a lower surface 512a of the roller cleaning blade 512 in the vertical direction is the abutting angle θ1 set in advance. In this embodiment, roller diameters RD51, RD511, and R52 of the developing roller 51, the cleaning roller 511, and the intermediate application roller 52 are respectively set to:

### RD51=66.8 mm

### RD511=32 mm

### RD52=52 mm.

As a result, the roller cleaning blade 512 can abut on the cleaning roller 511 at an abutting angle (blade angle) θ1 of

θ1=20 degrees.

In addition, in the specification, since the abutting angle is defined as described above, the abutting angle has a positive value when the abutting angle is inclined clockwise from the abutting portion CP1 as a starting point in the figure, and has a negative value when the abutting angle is inclined counterclockwise.

In addition, an inclined member 513 is disposed below the roller cleaning blade 512 in the vertical direction and above the intermediate application roller 52 in the vertical direction. An end portion of the inclined member 513 on the developing roller side (on the left of FIG. 17) is higher than an end portion thereof on the opposite side to the developing roller (on the right of FIG. 17) and the inclined member 513 is inclined downward in the vertical direction as it goes from the developing roller 51. In addition, the inclined member 513 is fixed to a developing device support unit (not shown) so that the end portion thereof on the developing roller side is positioned below the roller cleaning blade 512 in the vertical direction. In this embodiment, as illustrated in FIG. 18, the length W513 of the inclined member 513 in the rotation axis direction X is greater than the length W512 of the roller cleaning blade 512 in the rotation axis direction X, that is,

### W513>W512.

Moreover, the length W513 of the inclined member 513 in the rotation axis direction X is greater than the length W52 (of which illustration is omitted in FIG. 18) of the intermediate application roller 52 in the rotation axis direction X, that is,

### W513>W52.

Therefore, the inclined member 513 receives all the liquid developer (waste liquid) recovered by the roller cleaning blade 512 without dropping the liquid developer onto the intermediate application roller 52 so as to be guided in a direction to the side opposite to the developing roller away from the intermediate application roller 52. In addition, as illustrated in FIG. 18, fences 513a extending upward are formed at both end portions of the inclined member 513 in the rotation axis direction X so as to prevent the waste liquid from overflowing from both end portions of the inclined member 513, so that the waste liquid can be reliably recovered.

The cleaning blade 521 abuts on the intermediate application roller 52 and thus does not contribute to development and scrapes off the liquid developer remaining on the intermediate application roller 52 from the surface of the intermediate application roller 52 so as to be removed. An end portion of the cleaning blade 521 on the opposite side to the intermediate application roller (on the right of FIG. 17) is connected to an inclined member 522. An end portion of the inclined member 522 on the intermediate application roller side (on the left of FIG. 17) is higher than an end portion thereof on the opposite side to the intermediate application roller (on the right of FIG. 17) and the inclined member 522 is inclined downward in the vertical direction as it goes from the intermediate application roller 52. In addition, the inclined member 522 is fixed to the developer support unit so that the end portion thereof on the intermediate application roller side is positioned below the end portion of the inclined member 513 on the opposite side to the developing roller, and the end portion thereof on the opposite side to the intermediate application roller is disposed above a recovery unit 541 of the developer container 54 in the vertical direction. In this embodiment, the length W522 of the inclined member 522 in the rotation axis direction X is greater than the length (not shown) of the cleaning blade 521 in the rotation axis direction X. Moreover, the length W522 of the inclined member 522 in the rotation axis direction X is greater than the length W513 of the inclined member 513 in the rotation axis direction X, that is,

### W522>W513.

Accordingly, as illustrated in FIG. 20, all the liquid developer (waste liquid) scraped off by the blade 521 is guided toward the opposite side to the intermediate application roller along the inclined member 522, and the waste liquid guided by the inclined member 513 so as to fall down (the liquid developer cleaned and removed from the developing roller 51) is received by the end portion of the inclined member 522 on the intermediate application roller side so as to be guided toward the opposite side to the intermediate application roller.

A toner compression corona generator 55 is disposed on the upstream side of the rotation direction D51 of the developing roller 51 with respect to the development position in a posture that does not intersect the virtual vertical plane VP51. The toner compression corona generator 55 is an electric field application unit that increases a bias of the surface of the developing roller 51, and an electric field is applied to the toner of the liquid developer transported by the developing roller 51 at a position close to the toner compression corona generator 55, thereby performing charging and compression. As described above, in this embodiment, the toner compression corona generator 55 functions as a “toner discharging unit” of the invention.

As described above, in the eighth embodiment, as illustrated in FIG. 19A, the cleaning roller 511 is disposed in a posture in which a part of the peripheral surface of the cleaning roller 511 crosses the virtual vertical plane VP51S (on the right in the same figure), and the cleaning blade 512 abuts on the peripheral surface of the cleaning roller 511 that crosses the virtual vertical plane VP51S toward the site opposite to the developing roller. Therefore, cleaning by the cleaning blade 512 is performed at a position distant from the developing roller 51, so that the absolute value of the abutting angle (blade angle) θ1 can be reduced. For example, in a first comparative example illustrated in FIG. 19B, that is, in a case where the cleaning roller 511 is omitted and the cleaning blade 512 is caused to directly abut on the developing roller 51, the absolute value of an abutting angle θ0 of the cleaning blade 512 needs to be greater than the absolute value of the abutting angle θ1. For example, as described above, since the roller diameters RD51 and R52 of the developing roller 51 and the intermediate application roller 52 are respectively set to 66.8 mm and 52 mm, the abutting angle (blade angle) θ0 of the roller cleaning blade 512 with respect to the developing roller 51 is about

θ0=40 degrees.

It is difficult to reduce the absolute value of the abutting angle θ0 to be smaller than this.

As such, according to the eighth embodiment, the liquid developer scraped by the cleaning blade 512 can be caused to effectively fall down by gravity so as to be transported and recovered by the recovery unit 541 of the developer container 54. As a result, even though the liquid developer remaining on the developing roller 51 while containing agglutinated toner and thus having a high viscosity is scraped by the cleaning blade 512, the liquid developer can be prevented from being deposited on the front end of the cleaning blade 512, so that the liquid developer recovered by the cleaning mechanism can be appropriately and effectively transported and recovered.

In addition, in this embodiment, since the toner compression corona generator 55 for compressing the toner so as to be agglutinated on the surface of the developing roller 51 is disposed below the virtual horizontal plane HP51 in the vertical direction which passes through the developing roller 51, when the liquid developer adhered to the surface of the developing roller 51 drops and thus adheres to and contaminates the toner compression corona generator 55, this contamination causes unevenness of an image. However, since the toner compression corona generator 55 is disposed in a posture that does not intersect the virtual vertical plane VP51, the toner compression corona generator 55 can be prevented from being contaminated by the liquid developer dropping from the developer roller 51.

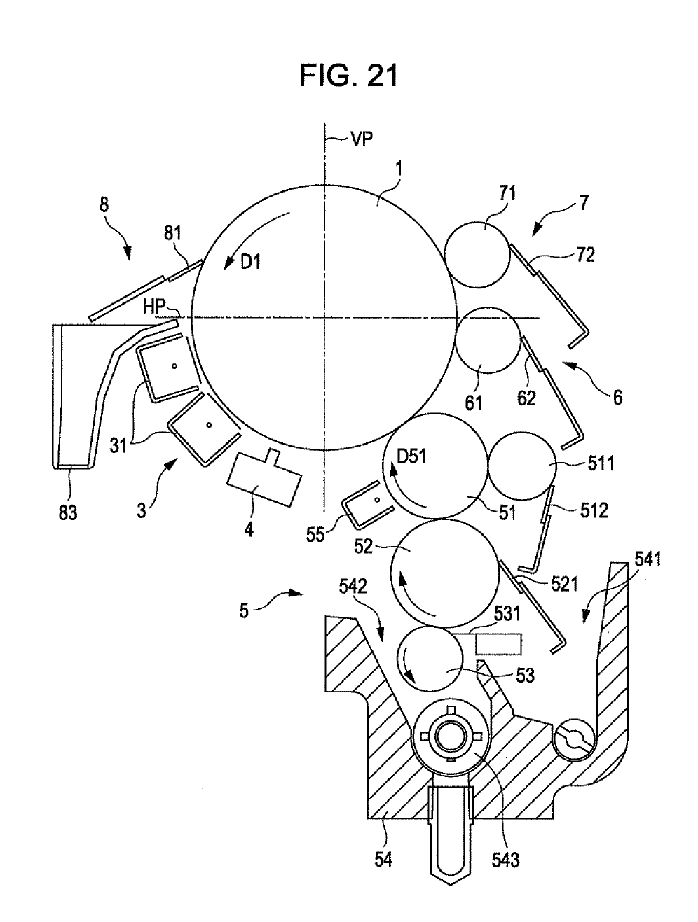

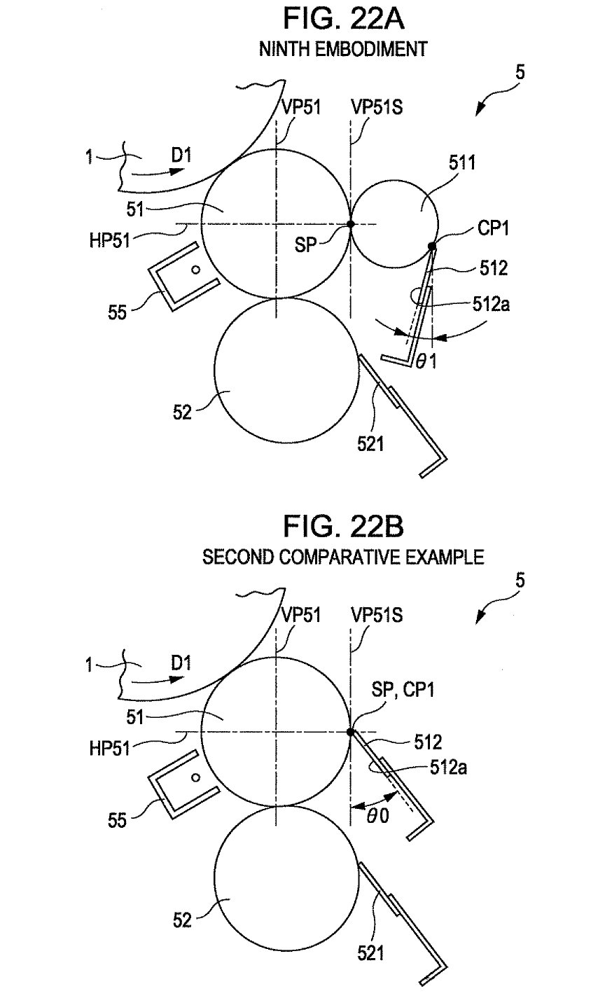

However, in the eighth embodiment, the invention is applied to an image forming apparatus having the so-called lower part transfer structure. However, for example, as illustrated in FIG. 21, the invention can also be applied to an image forming apparatus having an upper part transfer structure. Hereinafter, the ninth embodiment of the invention will be described with reference to FIGS. 21 to 22B.

FIG. 21 is a diagram illustrating an image forming apparatus including a developing device according to the ninth embodiment of the invention, and FIGS. 22A and 22B are diagrams illustrating an abutting angle of a cleaning blade according to the ninth embodiment. The image forming apparatus according to the ninth embodiment is significantly different from that of the eighth embodiment in that a transfer position where a toner image held by the photoconductive drum 1 is transferred onto a transfer medium is above the virtual horizontal plane HP passing through the rotation center of the photoconductive drum 1 in the vertical direction, and the basic configuration other than the different is the same. Therefore, hereinafter, the difference will be mainly described, and like elements are denoted by like reference numerals and detailed description thereof will be omitted.

The image forming apparatus including the developing device according to the ninth embodiment has the so-called upper part transfer structure in which an image held by the photoconductive drum 1 is transferred on a transfer medium (not shown) of a primary transfer unit such as an intermediate transfer belt or an intermediate transfer drum above the virtual horizontal plane HP passing through the rotation center of the photoconductive drum 1 in the vertical direction and the image transferred onto the transfer medium is transferred onto transfer paper. Even in the image forming apparatus, similarly to the eighth embodiment, in the periphery of the photoconductive drum 1, a charging unit 3 that charges the surface of the photoconductive drum 1 to a predetermined potential using two chargers 31, an exposure unit 4 that exposes the surface of the photoconductive drum 1 according to an image signal so as to form an electrostatic latent image, a developing unit 5 that develops the electrostatic latent image with a liquid developer so as to form a toner image, a first squeeze unit 6, a second squeeze unit 7, the transfer medium (not shown) of the primary transfer unit, and a photoconductor cleaning unit 8 that cleans the surface of the photoconductive drum 1 after primary transfer are arranged in this order along the rotation direction D1 (counterclockwise in FIG. 21) of the photoconductive drum 1. More specifically, the units are arranged as follows.

In FIG. 21, the charging unit 3 and the exposure unit 4 are disposed on the left with respect to the virtual vertical plane VP passing through the rotation center of the photoconductive drum 1 and below the virtual horizontal plane HP passing through the rotation center of the photoconductive drum 1 in the vertical direction. In addition, in FIG. 21, the developing unit 5 and the first squeeze unit 6 are disposed on the right with respect to the virtual vertical plane VP and below the virtual horizontal plane HP in the vertical direction. In addition, in FIG. 21, the second squeeze unit 7 is disposed on the right with respect to the virtual vertical plane VP and above the virtual horizontal plane HP in the vertical direction. In addition, in FIG. 21, the photoconductor cleaning unit 8 is disposed on the left with respect to the virtual vertical plane VP and above the virtual horizontal plane HP in the vertical direction. In addition, transfer of the toner image formed on the photoconductive drum 1 onto the transfer medium is performed between the second squeeze unit 7 and the photoconductor cleaning unit 8.

The developing unit 5 of the components corresponds to the developing device according to the ninth embodiment of the invention and is configured as follows.

As illustrated in FIGS. 21, 22A, and 22B, similarly to the eighth embodiment, the developing unit 5 has a so-called three-roller configuration including a developing roller 51, an intermediate application roller 52, and an anilox roller 53. Each of the rollers 51 to 53 has the same configuration as that of the eighth embodiment except for the arrangement position and is disposed so that the rotation axis is parallel to the rotation axis of the photoconductive drum 1 and both end portions are axially supported by a pair of side plates of which illustration is omitted, so as to be rotatable.

The developing roller 51 is disposed on the right with respect to the virtual vertical plane VP in FIG. 21 and below the virtual horizontal plane HP in the vertical direction, and as illustrated in FIG. 22A, abuts on the photoconductive drum 1 on the left in the same figure with respect to a virtual vertical plane VP51 passing through the rotation center of the developing roller 51 above a virtual horizontal plane HP51 passing through the rotation center of the developing roller 51 in the vertical direction. The developing roller 51 is connected to a developing motor (not shown) and is driven to rotate clockwise D51 in FIG. 21 so as to rotate along with the photoconductive drum 1. In addition, the developing roller 51 is electrically connected to a developing bias generation unit of which illustration is omitted so that a developing bias is applied to the developing roller 51 at an appropriate timing. Accordingly, a latent image held by the photoconductive drum 1 is developed. The intermediate application roller 52 abuts on the developing roller 51 below the developing roller 51 in the vertical direction so as to supply the liquid developer. Moreover, the anilox roller 53 abuts on the intermediate application roller 52 under the intermediate application roller 52 in the vertical direction so as to supply the liquid developer.

Next, a cleaning mechanism of the developing roller and the intermediate application roller according to the ninth embodiment will be described. As illustrated in FIGS. 21, 22A, and 22B, a cleaning roller 511 abuts on the developing roller 51, and a roller cleaning blade 512 abuts on the cleaning roller 511 so as to perform a cleaning process on the developing roller 51. More specifically, as illustrated in FIGS. 22A and 22B the cleaning roller 511 abuts on the developing roller 51 adjacent to the side opposite to photoconductive drum (on the right in the same figure) with respect to the developing roller 51. That is, the cleaning roller 511 abuts on the developing roller 51 substantially on the virtual horizontal plane HP51 and in a posture in which the entire peripheral surface crosses a virtual vertical plane VP51S passing through a position SP on the side opposite to the photoconductive drum where the virtual horizontal plane HP51 intersects the peripheral surface of the developing roller 51, toward the side opposite to the developing roller (on the right in the same figure). In addition, the cleaning roller 511 is rotated clockwise in FIG. 21 while abutting on the surface of the developing roller 51. Therefore, the cleaning roller 511 is rotated in the counter direction to the developing roller 51, and thus does not contribute to development and removes the liquid developer remaining on the developing roller 51.

In the ninth embodiment, on the side opposite to the developing roller with respect to the virtual vertical plane VP51S (on the right in FIGS. 22A and 22B), the roller cleaning blade 512 abuts on the surface of the cleaning roller 511 at an abutting angle θ1 (blade angle) to scrape off and remove the liquid developer. That is, an angle between the vertical virtual plane VP1 extending downward in the vertical direction from an abutting portion CP1 where the roller cleaning blade 512 abuts on the cleaning roller 511 and a lower surface 512a of the roller cleaning blade 512 in the vertical direction is the abutting angle θ1 (>0) set in advance. In this embodiment, roller diameters RD51, RD511, and R52 of the developing roller 51, the cleaning roller 511, and the intermediate application roller 52 are respectively set to:

### RD51=32 mm

### RD511=20 mm

### RD52=32 mm.

As a result, the roller cleaning blade 512 can abut on the cleaning roller 511 at an abutting angle (blade angle) θ1 of

θ1=15 degrees.

In the ninth embodiment, the abutting position of the roller cleaning blade 512 is a position offset to the side opposite to the photoconductive drum from the virtual vertical plane VP51S (on the right of FIG. 22) by the roller diameter of the roller cleaning blade 512, and the intermediate application roller 52 is not present below the abutting position in the vertical direction. Therefore, the inclined member 513 is not provided.

In addition, a toner compression corona generator 55 is disposed on the upstream side of the rotation direction D51 of the developing roller 51 in a posture that does not intersect the virtual vertical plane VP 51. In addition, in the ninth embodiment, as illustrated in FIG. 22A, the toner compression corona generator 55 is disposed on the photoconductive drum side with respect to the virtual vertical plane VP51 (on the left in the same figure) and below the virtual horizontal plane HP51 in the vertical direction.

As described above, in the ninth embodiment, as illustrated in FIG. 22A, the cleaning roller 511 is disposed in a posture in which the entirety of the cleaning roller 511 crosses the virtual vertical plane VP51S toward the site opposite to the developing roller (to the right of the same figure), and the cleaning blade 512 is caused to abut on the peripheral surface of the cleaning roller 511 that crosses the virtual vertical plane VP51S toward the side opposite to the developing roller, so that cleaning by the cleaning blade 512 is performed at a position distant from the developing roller 51, thereby reducing the abutting angle (blade angle) θ1. For example, in a second comparative example illustrated in FIG. 22B, that is, in a case where the cleaning roller 511 is omitted and the cleaning blade 512 is caused to directly abut on the developing roller 51, the absolute value of the abutting angle θ0 of the cleaning blade 512 needs to be greater than the absolute value of the abutting angle θ1. For example, as described above, since the roller diameters RD51 and R52 of the developing roller 51 and the intermediate application roller 52 respectively are set to 32 mm and 32 mm, the abutting angle (blade angle) θ0 of the roller cleaning blade 512 with respect to the developing roller 51 is about

θ0=32 degrees.

It is difficult to reduce the absolute value of the abutting angle θ0 to be smaller than this.

As such, according to the ninth embodiment, the liquid developer scraped by the cleaning blade 512 can be caused to effectively fall down by gravity so as to be transported and recovered by the recovery unit 541 of the developer container 54. As a result, the same operation effects as those of the eighth embodiment can be obtained.

In addition, in the ninth embodiment, since the toner compression corona generator 55 is disposed in a posture that does not intersect the virtual vertical plane VP54, similarly to the eighth embodiment, the toner compression corona generator 55 can be prevented from being contaminated by the liquid developer dropping from the developer roller 51.

As described above, a configuration may be employed in which the developer holder roller abuts on the latent image holder below the virtual horizontal plane in the vertical direction so as to form a latent image, and the developer holder cleaning roller abuts on the developer holder roller above the virtual horizontal plane in the vertical direction.

In addition, a supply member that abuts on the developer holder roller on the first side of the first virtual vertical plane and below the virtual horizontal plane in the vertical direction and supplies the liquid developer may be included.

In addition, the developer holder roller may also be configured to abut on the latent image holder above the virtual horizontal plane in the vertical direction so as to develop the latent image.

Moreover, the toner charging unit is a corona charger having wires and grids, and the wires may be disposed at a position different from the virtual vertical plane.

In addition, the invention is not limited to the above-described embodiments, and various modifications besides the above described embodiments can be made without departing from the gist. For example, in the above-described embodiments, the invention is applied to the developing unit 5 having the so-called three-roller configuration. However, an object to which the invention is applied is not limited to this, and the invention can also be applied to a developing device having a configuration in which the liquid developer is directly applied to the developing roller 51 from the anilox roller 53 (two-roller configuration).

In addition, in the above-described embodiment, the toner compression corona generator 55 is used as the “toner charging unit” for performing toner charging and compression. However, a compaction roller for charging through contact may also be used as the “toner charging unit”.

Next, seventh to ninth embodiments of the invention will be described. Hitherto, an image forming apparatus of a liquid developing type in which an electrostatic latent image is formed on a latent image holder such as a charged photoconductive drum, the electrostatic latent image is developed by a liquid developer made by dispersing a toner in a carrier liquid thereby so as to form a toner image, and the toner image is transferred onto a sheet via an intermediate transfer body thereby forming a predetermined image has been commercialized. In addition, a developing unit of the image forming apparatus recovers and reuses a developer component that is not printed on the sheet from the supplied liquid developer (for example, JP-A-2009-237055 (FIG. 2)).

However, in the developing unit described above, the liquid developer recovered from a developing roller has the highest concentration and is in an agglutinated state by being compressed by a developer layer compression unit before development or an electric field of a non-image portion during development. Therefore, the liquid developer is likely to be stayed in a recovery path, and there may be cases where agitating characteristics of the liquid developer recovered in an agitating and adjusting tank and a liquid developer that is newly supplied is degraded or the agglutinated state of the liquid developer is remained. As a result, there is a problem in that the liquid developer is not homogenous.

An advantage of some aspects of the invention is that it provides a recovery device capable of enhancing agglutination crushing characteristics of a toner contained in a recovered liquid developer, and a developing device and an image forming apparatus including the recovery device.

The recovery device according to the seventh embodiment of the invention includes: a recovery unit which stores a liquid developer containing a recovered toner and a carrier liquid; a transportation member which moves the liquid developer stored in the recovery unit from one end of the recovery unit to the other end thereof; and a recovery path member which causes the liquid developer to flow to the recovery unit and causes the amount of the liquid developer flowing to the one end side of the recovery unit to be greater than the amount of the liquid developer flowing to the other end side.

The developing device according to the eighth embodiment of the invention includes: a developer holder roller which holds a liquid developer containing a toner and a carrier liquid; a developer holder cleaning unit which cleans the developer holder roller and recovers the liquid developer from the liquid developer roller; a recovery unit which stores the liquid developer recovered from the developer holder roller by the developer holder cleaning unit; a transportation member which moves the liquid developer stored in the recovery unit from one end in an axial direction of the developer holder roller to the other end; and a recovery path member which causes the liquid developer recovered from the developer holder roller by the developer holder cleaning unit to flow to the recovery unit and causes the amount of the liquid developer flowing to the one end side of the recovery unit to be greater than the amount of the liquid developer flowing to the other end side of the recovery unit.

Moreover, the image forming apparatus according to the ninth embodiment of the invention includes: a latent image holder on which a latent image is formed; an exposure unit which exposes the latent image holder to form the latent image; a developing unit which includes a developer holder roller that holds a liquid developer and a developer holder cleaning unit that cleans the developer holder roller and recovers the liquid developer from the developer holder roller and forms the latent image using the liquid developer containing a toner and a carrier liquid; a recovery unit which stores the liquid developer recovered from the developer holder roller by the developer holder cleaning unit; a transportation member which moves the liquid developer transported to the recovery unit from one end in an axial direction of the developer holder roller to the other end; and a recovery path member which causes the liquid developer recovered from the developer holder roller by the developer holder cleaning unit to flow to the recovery unit and causes the amount of the liquid developer flowing to the one end side of the recovery unit to be greater than the amount of the liquid developer flowing to the other end side of the recovery unit.

In the embodiments of the invention (the recovery device, the developing device, and the image forming apparatus) configured as described above, the liquid developer is caused to flow from the recovery path member to the recovery unit and is moved from the one end side of the recovery unit to the other end side thereof by the transportation member in the recovery unit. Here, the recovery path member causes the amount of the liquid developer flowing to the one end side of the recovery unit to be greater than the amount of the liquid developer flowing to the other end side of the recovery unit. Therefore, much of the liquid developer recovered in the recovery unit is moved from the one end side of the recovery unit to the other end side, so that agglutinated toner is crushed during the movement and is agitated in the liquid developer.

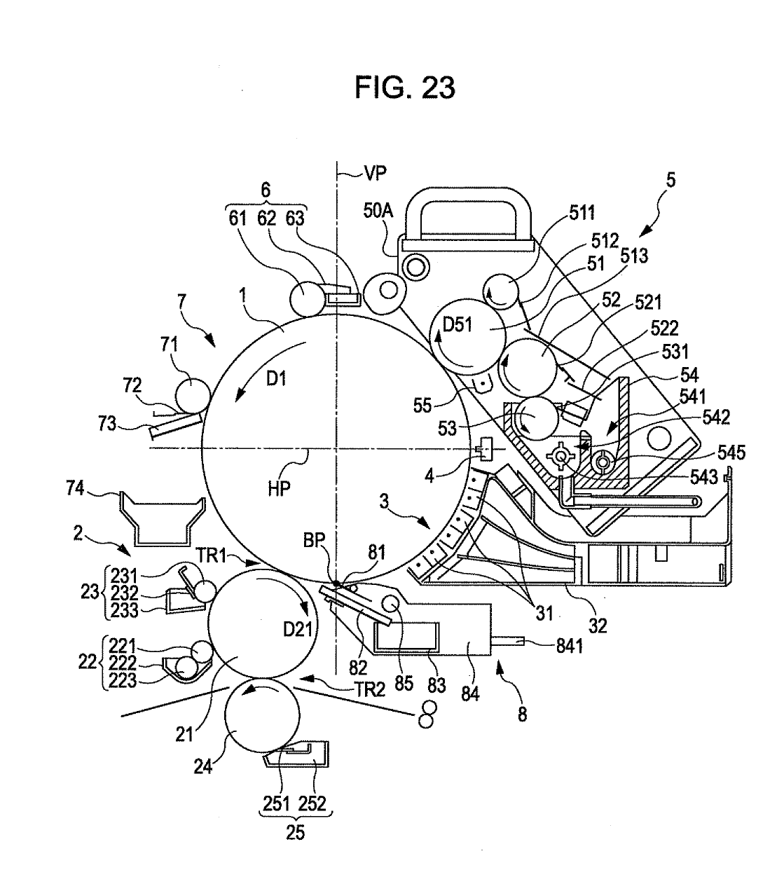

FIG. 23 is a diagram illustrating an image forming apparatus including a developing device according to a tenth embodiment of the invention. In the tenth embodiment, description which is common to the first embodiment will be omitted, and like elements are denoted by like reference numerals in FIG. 1 and detailed description thereof will be omitted.

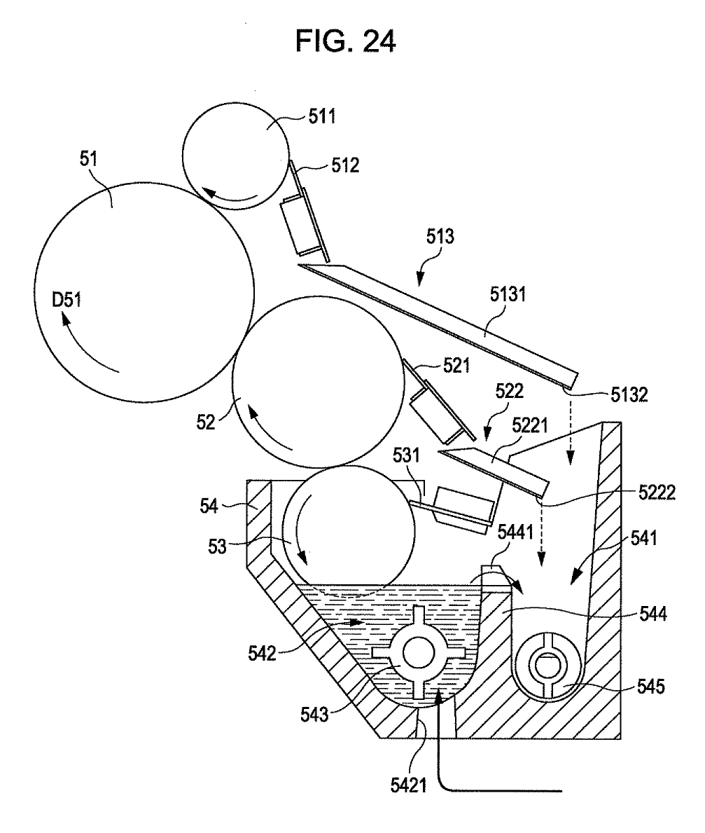

The configuration and the operation effects of a developing unit 5 will be described with reference to FIGS. 23 to 28. FIG. 24 is a diagram illustrating the developing unit included in the image forming apparatus of FIG. 23.

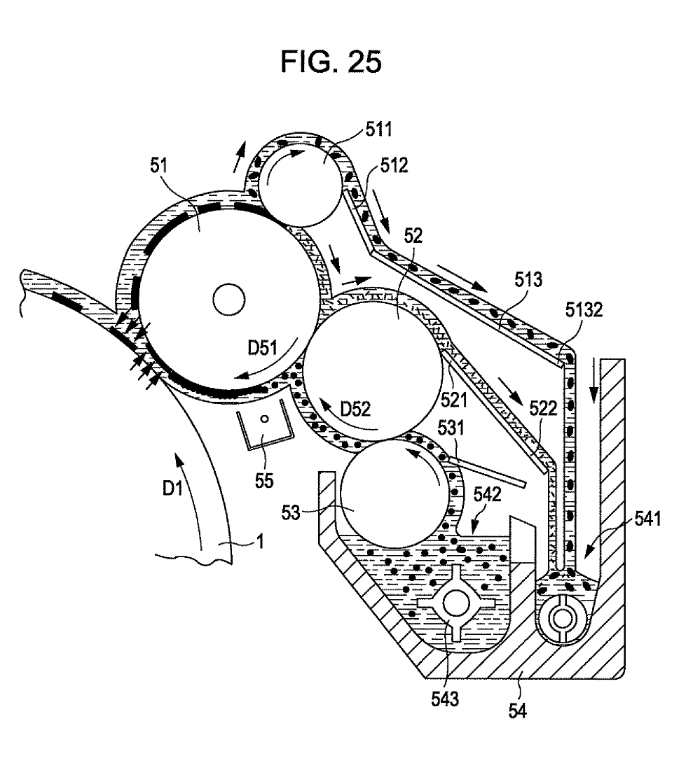

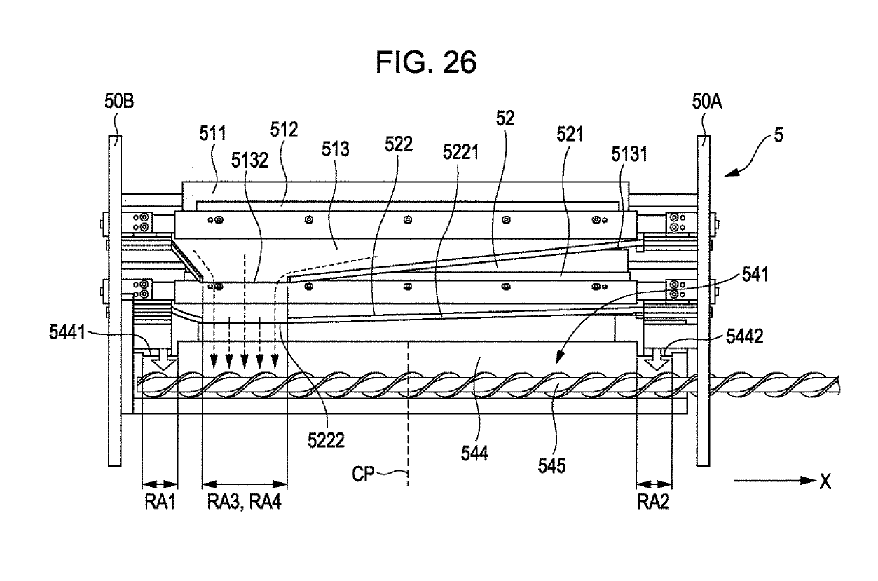

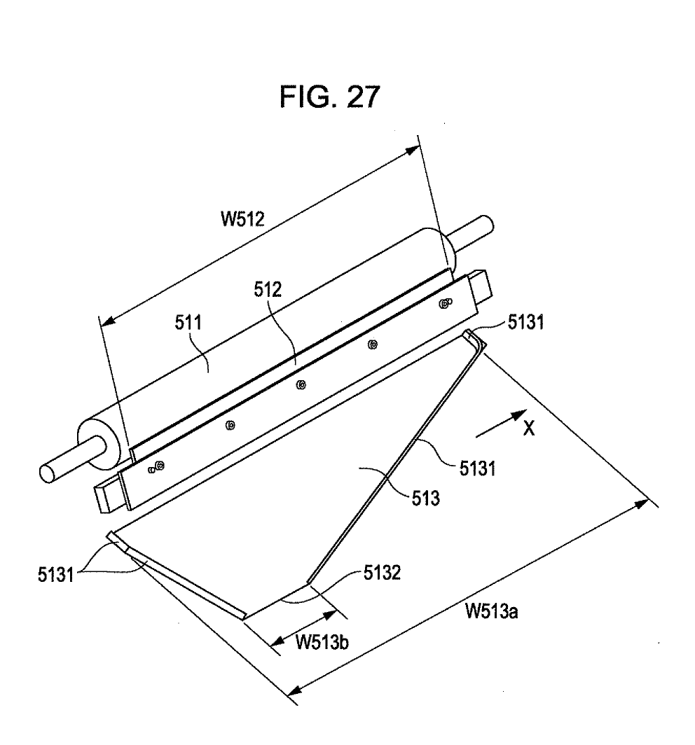

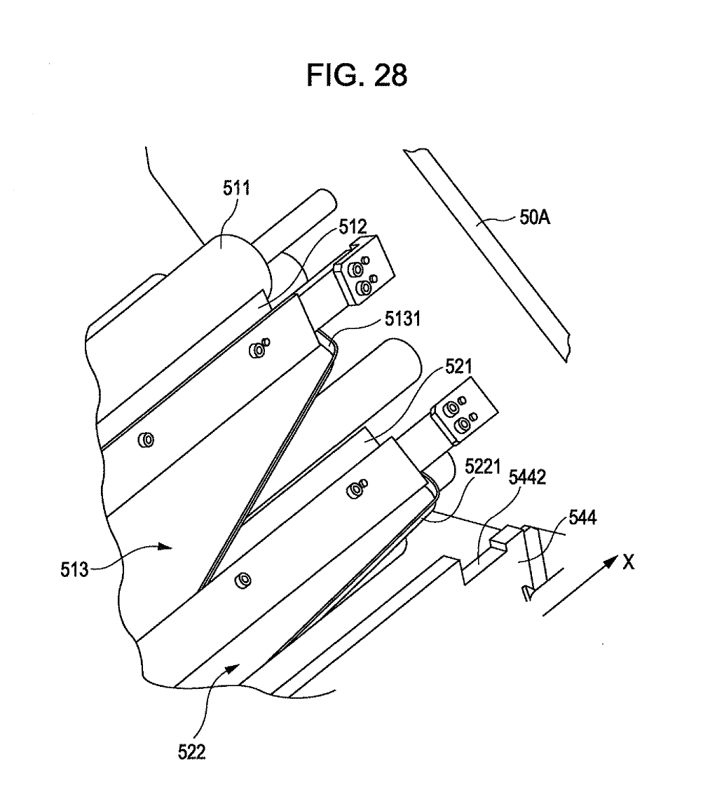

FIG. 25 is a schematic diagram illustrating a recovery path of a recovery liquid recovered by the developing unit. FIG. 26 is a diagram viewed from a side opposite to a photoconductive drum. FIG. 27 is a diagram illustrating a cleaning unit of a developing roller. FIG. 28 is a partially enlarged view of a recovery path member. As illustrated in FIGS. 23 and 24, the developing unit 5 is mainly configured of a developing roller 51, an intermediate application roller 52, an anilox roller 53, a developer container 54 which stores the liquid developer, and a toner compression corona generator 55 which performs a charging and compression operation on the liquid developer. Each of the rollers 51 to 53 is disposed so that the rotation axis is parallel to the rotation axis of the photoconductive drum 1 and both end portions are axially supported by a pair of side plates 50A and 50B so as to be rotatable. More specifically, each of the rollers 51 to 53 is configured as follows.

The developing roller 51 is a cylindrical member and is made by providing an elastic layer such as polyurethane rubber, silicon rubber, or NBR on the outer peripheral portion of an inner core made of a metal such as iron and coating a PFA tube or resin on the surface layer of the developing roller which is a further outer peripheral portion. The developing roller 51 is connected to a developing motor (not shown) and is driven to rotate clockwise D51 in FIG. 23 so as to rotate along with the photoconductive drum 1. In addition, the developing roller 51 is electrically connected to a developing bias generation unit of which illustration is omitted so that a developing bias is applied to the developing roller 51 at an appropriate timing.

In addition, in order to supply the liquid developer to the developing roller 51, the intermediate application roller 52 and the anilox roller 53 are provided, and the liquid developer is supplied to the developing roller 51 from the anilox roller 53 via the intermediate application roller 52. Of the rollers, the intermediate application roller 52 is made by providing an elastic layer on the outer peripheral portion of an inner core made of metal similarly to the developing roller 51, and the anilox roller 53 is a roller in which a concave pattern is formed of spiral grooves or the like carved finely and uniformly on the surface so as to easily hold the liquid developer. Of course, similarly to the developing roller 51 or the intermediate application roller 52, the anilox roller 53 may use one made by winding a rubber layer such as urethane or NBR or coating a PFA tube around a metal core. The intermediate application roller 52 and the anilox roller 53 are connected to the developing motor and are rotated clockwise and counterclockwise in FIG. 23, respectively. Therefore, the intermediate roller 52 is rotated in the counter direction to the developing roller 51, and the anilox roller 53 is rotated along with the intermediate application roller 52. As described above, in this embodiment, since the liquid developer is supplied to the developing roller 51 from a developer container 54 by the so-called three-roller configuration, as the liquid developer passes through the nips a plurality of times, the liquid developer can be kneaded, and thus a uniform liquid developer film can be formed on the developing roller 51.

In this embodiment, a developer holder cleaning unit is provided in order to clean and remove the liquid developer from the developing roller 51. The developer holder cleaning unit has a cleaning roller 511 and a roller cleaning blade 512. The cleaning roller 511 abuts on the developing roller 51 and the roller cleaning blade 512 abuts on the cleaning roller 511 so as to perform a cleaning process of the developing roller 51. More specifically, the cleaning roller 511 abuts on the surface of the developing roller on the downstream side of the rotation direction D51 of the developing roller 51 with respect to a development position where the surface of the developing roller 51 abuts on the photoconductive drum 1 and thus forms a development nip, and is rotated clockwise in FIGS. 23 and 24. Therefore, the cleaning roller 511 is rotated in the counter direction to the developing roller 51, and thus does not contribute to development and removes the liquid developer remaining on the developing roller 51. In addition, the roller cleaning blade 512 abuts on the surface of the cleaning roller 511 so as to scrape off and remove the liquid developer.

An inclined member 513 is disposed below the roller cleaning blade 512 in the vertical direction and above the intermediate application roller 52 in the vertical direction. An end portion of the inclined member 513 on the developing roller side (on the left of FIG. 24) is higher than an end portion thereof on the opposite side to the developing roller (on the right of FIG. 24) and the inclined member 513 is inclined downward in the vertical direction as it goes from the developing roller 51 and extends to the upside of a recovery unit 541 of a developer container 54. In addition, the inclined member 513 is fixed to side plates 50A and 50B so that the end portion thereof on the developing roller side is positioned below the roller cleaning blade 512 in the vertical direction. In this embodiment, as illustrated in FIG. 27, the length W513a in the rotation axis direction X of the end portion of the inclined member 513 on the developing roller side is greater than the length W512 in the rotation axis direction X of the roller cleaning blade 512, that is,

### W513a>W512.

In the inclined member 513, as illustrated in FIGS. 26 and 27, side fences (wall portions) 5131 are erected upward in the vertical direction at both end sides in the width direction X. In addition, each of the side fences 5131 extends toward an end portion 5132 of the inclined member 513 on the side opposite to the developing roller (lower right side of FIG. 27) so as to guide the liquid developer (waste liquid) to the upside of the recovery unit 541 in the vertical direction. In addition, the liquid developer recovered from the position drops onto the recovery unit 541 from the end portion of the inclined member 513 on the side opposite to the developing roller. Therefore, the inclined member 513 receives all the liquid developer (waste liquid) recovered by the roller cleaning blade 512 so as to flow to the recovery unit 541 of the developer container 54. As such, in this embodiment, the inclined member 513 functions as a “recovery path member” of the invention, and the end portion 5132 of the inclined member 513 on the side opposite to the developing roller corresponds to a “discharge portion” of the invention.

Moreover, as illustrated in FIG. 27, the interval between both the side fences 5131 in the width direction X is narrowed toward the end portion 5132 on the side opposite to the developing roller, and a length W513b in the rotation axis direction X of the end portion 5132 on the side opposite to the developing roller becomes narrower than a length W513a in the rotation axis direction X of the end portion on the developing roller side. Moreover, as illustrated in FIG. 26, the end portion 5132 of the inclined member 513 on the side opposite to the developing roller is positioned further towards the upstream side than the center portion in the transportation direction X of the liquid developer in the recovery unit 541. In addition, this point will be described later.

In addition, the cleaning blade 521 abuts on the intermediate application roller 52 and thus scrapes off and removes the liquid developer that does not contribute to development and remains on the intermediate application roller 52 from the surface of the intermediate application roller 52. As described above, in this embodiment, the intermediate application roller 52 and the cleaning blade 521 respectively function as a “supply member” and a “supply member cleaning unit” of the invention.

An inclined member 522 is disposed below the cleaning blade 521 in the vertical direction. Similarly to the inclined member 513, an end portion of the inclined member 522 on the intermediate application roller side (on the left of FIG. 24) is higher than an end portion thereof on the opposite side to the intermediate application roller (on the right of FIG. 24) and the inclined member 522 is inclined downward in the vertical direction as it goes from the intermediate application roller 52 and extends to the upside of the recovery unit 541 of the developer container 54. In addition, the inclined member 522 is fixed to the side plates 50A and 50B so that the end portion thereof on the intermediate application roller side is positioned below the cleaning blade 521 in the vertical direction. In this embodiment, although illustration is omitted, the length in the rotation axis direction X of the end portion of the inclined member 522 on the intermediate application roller side is greater than the length in the rotation axis direction X of the cleaning blade 521.

In the inclined member 522, as illustrated in FIG. 26, side fences (wall portions) 5221 are erected upward in the vertical direction at both end sides in the width direction X. In addition, each of the side fences 5221 extends toward an end portion 5222 of the inclined member 522 on the side opposite to the intermediate application roller so as to guide the liquid developer (waste liquid) to the upside of the recovery unit 541 in the vertical direction from the end portion 5222 of the inclined member 522 on the side opposite to the intermediate application roller. In addition, the liquid developer recovered from the position drops onto the recovery unit 541. Therefore, the inclined member 522 receives all the liquid developer (waste liquid) recovered by the cleaning blade 521 so as to flow to the recovery unit 541 of the developer container 54. As such, in this embodiment, the inclined member 522 functions as a “second recovery path member” of the invention, and the end portion 5222 of the inclined member 522 on the side opposite to the intermediate application roller corresponds to a “second discharge portion” of the invention.

Moreover, the interval between both the side fences 5221 in the width direction X is narrowed toward the end portion 5222 on the side opposite to the intermediate application roller, and the length in the rotation axis direction X of the end portion 5222 on the side opposite to the intermediate application roller becomes narrower than the length in the rotation axis direction X of the end portion on the intermediate application roller side. Moreover, as illustrated in FIG. 26, the end portion 5222 of the inclined member 522 on the side opposite to the developing roller is positioned further towards the upstream side than the center portion in the transportation direction X of the liquid developer in the recovery unit 541. In addition, this point will also be described later.

On the other hand, a restriction member 531 abuts on the anilox roller 53. As the restriction member 531, a member made of metal or a member having elasticity which is configured by coating an elastic body on the surface may be used. The restriction member 531 according to this embodiment is configured of a rubber portion made of urethane rubber or the like abutting on the surface of the anilox roller 53 and a plate made of metal or the like for supporting the rubber portion. In addition, the restriction member 531 has functions of restricting and adjusting the thickness, the amount, and the like of the liquid developer held and transported by the anilox roller 53 thereby adjusting the amount of the liquid developer supplied to the developing roller 51. In addition, the liquid developer scraped by the restriction member 531 is returned to a storage unit 542 of the developer container 54. An agitating member 543 is disposed in the storage unit 542 and is rotated by a motor of which illustration is omitted so as to agitate the liquid developer in the storage unit 542.

The storage unit 542 of the developer container 54 has the function of storing the liquid developer to be supplied to the developing roller 51 via the anilox roller 53 and the intermediate application roller 52 as described above, and as illustrated in FIG. 26, a liquid developer of which the concentration is adjusted is appropriately supplied to the storage unit 542 through supply holes 5421 provided at the center portion of the bottom surface of the storage unit 542. In addition, in the storage unit 542, the liquid developer is agitated by rotation of the agitating member 543 and is transported in the axial direction X thereof. In this embodiment, the transportation directions of the agitating member 543 are different with respect to the supply holes 5421 as boundaries, and the liquid developer flowing through the supply holes 5421 is divided to be transported to a front side and a rear side in the same figure.

In the developer container 54, a partitioning member 544 that partitions the recovery unit 541 and the storage unit 542 extends in the axial direction X. At both end portions of the partitioning member 544 in the axial direction X, as illustrated in FIG. 26, a first flowing opening 5441 and a second flowing opening 5442 are provided by partially cutting off the upper end of the partitioning member 544, so that the liquid developer transported into the storage unit 542 by the agitating member 543 overflows through the flowing openings 5441 and 5442 and flows to first and second recovery regions RA1 and RA2 of the recovery unit 541. As described above, an overflow structure is employed in which the storage unit 542 communicates with the recovery regions RA1 and RA2 of the recovery unit 541 through the flowing openings 5441 and 5442 and the liquid developer flows from the storage unit 542 to the recovery unit 541. Accordingly, the liquid surface level of the liquid developer in the storage unit 542 is maintained at a constant level, so that the liquid developer can be uniformly supplied to the developing roller 51 via the anilox roller 53 and the intermediate application roller 52.

As such, the liquid developer overflowing from the storage unit 542 and the liquid developer that is cleaned, removed, and recovered flow into the recovery unit 541. In addition, the liquid developer is transported in a direction X parallel to the rotation axis direction X of the developing roller 51 by an auger (recovery screw) 545 disposed in the recovery unit 541 so as to flow out from a transportation hole (not shown) that is open at the side surface of the recovery unit 541. As such, in this embodiment, the auger 545 functions as a “transportation member” of the invention.

Here, when the liquid developer recovered by cleaning the developing roller 51 is examined, the following facts can be found. Specifically, the liquid developer recovered as such has the highest concentration in the developing unit 5. In addition, the liquid developer is subjected to the compression operation by the toner compression corona generator 55 before development and is compressed by an electric field of a non-image portion during development, so that the toner in the liquid developer is in an agglutinated state due to these factors. However, in this embodiment, the recovery region RA3 onto which the liquid developer drops from the end portion (discharge portion) 5132 of the inclined member 513 on the side opposite to the developing roller is on the upstream side in the transportation direction X of the recovery unit 541, and thus the liquid developer is moved from the upstream side (the left of FIG. 26) in the transportation direction X of the recovery unit 541 to the downstream side (the right of the same figure), so that the agglutinated toner is crushed during the movement and is agitated in the liquid developer. As described above, by causing the amount of the liquid developer flowing to the recovery unit 541 from the inclined member 513 on the upstream side of the transportation direction X of the recovery unit 541 (on the left of FIG. 26) to be greater, the liquid developer can be sufficiently mixed while being transported by the auger 545, thereby obtaining excellent agitating characteristics and crushing performance.

In addition, the liquid developer (intermediate roller recovery liquid) recovered by cleaning the intermediate application roller 52 has a low density and excellent flowability compared to the liquid developer recovered by cleaning the developing roller 51 (developing roller recovery liquid). In addition, in this embodiment, the recovery region RA4 in the recovery unit 541 onto which the liquid developer drops from the end portion (second discharge portion) 5222 of the inclined member 522 on the side opposite to the intermediate application roller is aligned with the recovery region RA3. Therefore, the developing roller recovery liquid is mixed with the intermediate roller recovery liquid, thereby enhancing flowability and agglutination crushing characteristics.

In addition, in this embodiment, the recovery regions RA3 and RA4 are set to positions to which the liquid developer overflowing from the flowing openings 5441 and 5442 (the liquid developer shown by the outline arrows in the same figure) flows, that is, regions between the recovery regions RA1 and RA2 of the recovery unit 541 that recovers the liquid developer. Therefore, the developing roller recovery liquid drops onto the overflowing liquid developer which has a low density and excellent flowability compared to the developing roller recovery liquid, thereby further enhancing flowability and agglutination crushing characteristics. Moreover, since the recovery regions RA3 and RA4 are set to the regions between the recovery regions RA1 and RA2 as described above, the liquid developer can be prevented from being concentrated in the recovery regions RA1 and RA2, and thus the liquid developer recovered in the recovery unit 541 can be prevented from flowing backward to the storage unit 542 via the flowing openings 5441 and 5442. In addition, the liquid developer can be prevented from overflowing from the developer container 54 to the recovery regions RA1 and RA2 and contaminating peripheral devices of the developing unit 5.

As described above, a configuration may be employed in which the recovery path member has the discharge portion which is disposed above the recovery unit in the vertical direction and discharges the liquid developer to the recovery unit and the wall portions disposed on the one end and the other end sides in the axial direction of the developer holder roller, and the wall portions guide the liquid developer recovered from the developer holder roller by the developer holder cleaning unit to the discharge portion.

In addition, a configuration may be employed in which the interval between the wall portions disposed on the one end and the other end sides in the axial direction of the developer holder roller is narrowed toward the discharge portion.

In addition, a configuration may be employed in which the storage unit which stores the liquid developer to be supplied to the developer holder roller, and the supply member which supplies the liquid developer stored in the storage unit to the developer holder roller, the supply member cleaning unit which cleans the supply member and recovers the liquid developer from the supply member, and the second recovery path member which has the second discharge portion disposed above the recovery unit in the vertical direction so as to discharge the liquid developer to the recovery unit and guides the liquid developer recovered from the supply member by the supply member cleaning unit to the recovery unit may be included.

In addition, the discharge portion may be disposed further towards the one end side of the recovery unit than the second discharge portion.

Moreover, a configuration may be employed in which the partitioning member which has the flowing openings through which the liquid developer flows to the one end and the other end sides in the axial direction of the developer holder roller and partitions the storage unit and the recovery unit is included, and the discharge portion and the second discharge portion discharge the liquid developer to a position between the flowing openings in the axial direction of the developer holder roller.

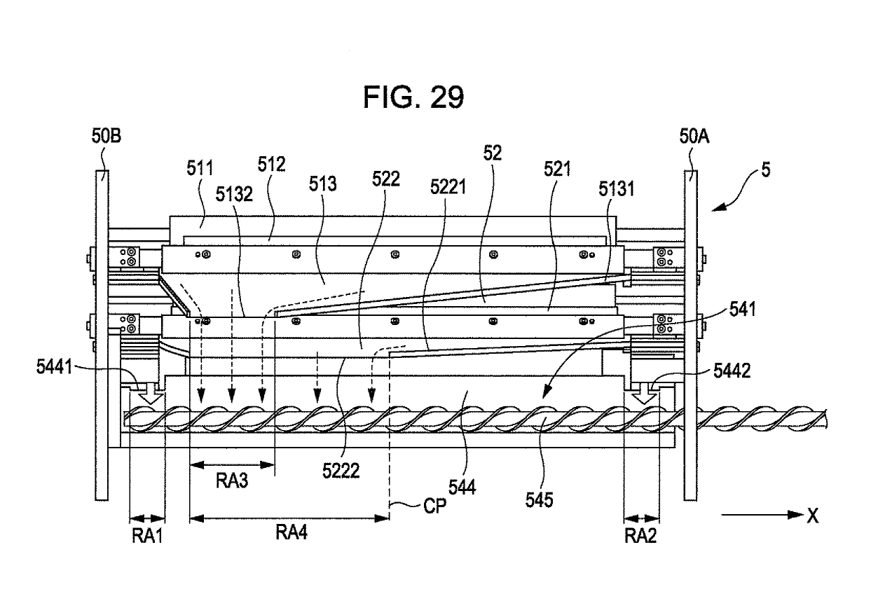

The invention is not limited to the above-described embodiments, and various modifications besides the above described embodiments can be made without departing from the gist. For example, in the tenth embodiment, the third recovery region RA3 to which the liquid developer flows from the inclined member 513 is configured to be aligned with the fourth recovery region RA4 to which the liquid developer flows from the inclined member 522. That is, the end portion (the second discharge portion) 5222 of the inclined member 522 on the side opposite to the intermediate application roller is positioned below the end portion (the discharge portion) 5132 of the inclined member 513 on the side opposite to the developing roller in the vertical direction and the widths of the two in the rotation axis direction X are equal to each other. Instead of this, for example, as illustrated in FIG. 29, the width of the end portion 5222 of the inclined member 522 on the side opposite to the intermediate application roller may be increased (eleventh embodiment). In the eleventh embodiment, an end portion of the fourth recovery region RA4 on the downstream side in the transportation direction X is positioned further towards the downstream side in the transportation direction X than the third recovery region RA3 (on the right in the same figure). That is, the position on the second flowing opening 5442 side of the end portion 5222 (the second discharge portion) of the inclined member 522 on the side opposite to the intermediate application roller is positioned further towards the second flowing opening 5442 side than the position on the second flowing opening 5442 side of the end portion 5132 (the discharge portion) of the inclined member 513 on the side opposite to the developing roller. Therefore, the developing roller recovery liquid can be caused to drop with a transportation width of the intermediate roller recovery liquid having good flowability, thereby enhancing agitating performance and transportation performance during transportation.

In addition, in the above-described embodiments, the cleaning roller 511 and the roller cleaning blade 512 are used as the cleaning unit of the developing roller 51. However, the configuration of the developer holder cleaning unit is not limited to this, and for example, the invention can also be applied to a developing device which causes the cleaning blade 512 to directly abut on and clean the developing roller 51. In this case, the cleaning blade 512 may be configured to support the inclined member 513 which is the recovery path member.

In addition, in the above-described embodiments, the invention is applied to the developing unit 5 having the so-called three-roller configuration. However, an object to which the invention is applied is not limited to this, and the invention can also be applied to a developing device having a configuration in which the liquid developer is directly applied to the developing roller 51 from the anilox roller 53 (two-roller configuration).

Moreover, in the above-described embodiments, the case where the invention is applied to the image forming apparatus having a so-called low part transfer structure will be described. However, an object to which the invention is applied is not limited to this, and for example, the invention can also be applied to an image forming apparatus having a so-called upper part transfer structure in which an image held by the photoconductive drum 1 is transferred above the virtual horizontal plane HP passing through the rotation center of the photoconductive drum 1 in the vertical direction.

The entire disclosure of Japanese Patent Application No. 2011-038276, filed Feb. 24, 2011, No. 2011-046141, filed Mar. 3, 2011, No. 2011-050440, filed Mar. 8, 2011 and No. 2011-114420, filed May 23, 2011 are expressly incorporated by reference herein.

What is claimed is:

1. A developing device comprising:
a developer holder roller which holds a liquid developer containing a toner and a carrier liquid;
a supply member which supplies the liquid developer to the developer holder roller;
a developer roller cleaning unit which cleans the developer holder roller and recovers the liquid developer;
a supply member cleaning unit which cleans the supply member and recovers the liquid developer;
a recovery path member which is disposed above the supply member in a vertical direction and receives the liquid developer recovered by the developer holder cleaning unit; and
a recovery unit which is disposed below the recovery path member in the vertical direction and stores the liquid developer moved to the recovery path member and the liquid developer recovered by the supply member cleaning unit.

2. The developing device according to claim 1,
wherein the supply member is a roller member which rotates while holding the liquid developer, and
a length of the recovery path member in an axial direction of the supply member is greater than a length of the supply member in the axial direction.

3. The developing device according to claim 1,
wherein the developer holder cleaning unit has a developer holder cleaning blade which moves the recovered liquid developer, and
the recovery path member is connected to the developer holder cleaning blade.

4. The developing device according to claim 3,
wherein the supply member cleaning unit has a supply member cleaning blade which moves the recovered liquid developer, and
the liquid developer moved by the recovery path member is moved by the supply member cleaning blade and is recovered in the recovery unit.

5. The developing device according to claim 4, wherein, assuming that a vertical plane including a first abutting portion where the developer holder cleaning blade abuts on the developing holder roller is a first vertical virtual plane and a vertical plane including a second abutting portion where the supply member cleaning blade abuts on the supply member is a second vertical virtual plane, an angle θ1 from the first virtual vertical plane to a lower surface of the developer holder cleaning blade in the vertical direction is smaller than an angle θ2 from the second virtual vertical plane to a lower surface of the supply member cleaning blade in the vertical direction.

6. The developing device according to claim 3,
wherein the developer holder cleaning unit has a developer holder cleaning roller which abuts on the developer holder roller, and
the developer holder cleaning blade abuts on the developer holder cleaning roller.

7. The developing device according to claim 1, further comprising a supply roller which has a groove on a peripheral surface and abuts on the supply member to supply the liquid developer to the supply member.

8. An image forming apparatus comprising:
a latent image holder on which a latent image is formed; and
a developing unit which includes a developer holder roller that holds a liquid developer containing a toner and a carrier liquid, a supply member which supplies the liquid developer to the developer holder roller, a developer roller cleaning unit which cleans the developer holder roller and recovers the liquid developer, a supply member cleaning unit which cleans the supply member and recovers the liquid developer, a recovery path member which is disposed above the supply member in a vertical direction and receives the liquid developer recovered by the developer holder cleaning unit, and a recovery unit which is disposed below the recovery path member in the vertical direction and stores the liquid developer moved to the recovery path member and the liquid developer recovered by the supply member cleaning unit, and develops the latent image formed on the latent image holder.

9. The developing device according to claim 1, comprising:
the developer holder roller which holds the liquid developer containing the toner and the carrier liquid;
a storage unit which stores the liquid developer to be supplied to the developer holder roller;
the developer holder cleaning unit which cleans the developer holder roller and removes the liquid developer from the developer holder roller;
the recovery unit which recovers the liquid developer removed from the developer holder roller by the developer holder cleaning unit;
a partitioning member which has a flowing unit that causes the liquid developer stored in the storage unit to flow to the recovery unit and partitions the storage unit and the recovery unit; and
the recovery path member which has a discharge unit that discharges the liquid developer to a position of the recovery unit which is different from that of the flowing unit in an axial direction of the developer holder roller, and recovers the liquid developer removed by the developer holder cleaning unit so as to flow to the recovery unit through the discharge unit.

10. The developing device according to claim 9, further comprising a transportation member which is disposed in the recovery unit and transports the liquid developer stored in the recovery unit in the axial direction of the developer holder roller,
wherein the flowing unit of the partitioning member includes a first flowing opening disposed on one end side of the axial direction of the developer holder roller and a second flowing opening disposed on the other end side in a direction opposite to the one end side of the axial direction of the developer holder roller,
the discharge unit of the recovery path member causes the liquid developer to flow to a position between the first and second flowing openings in the axial direction of the developer holder roller,
the transportation member transports the liquid developer stored in the recovery unit from a side of the first flowing opening to a side of the second flowing opening,
the discharge unit of the recovery path member causes the liquid developer to flow to a position on the side of the first flowing opening in the axial direction of the developer holder roller,
the supply member which supplies the liquid developer stored in the storage unit to the developer holder roller, the supply member cleaning unit which cleans the supply member and removes the liquid developer from the supply member, and a second recovery path member which includes a second discharge unit that discharges the liquid developer to a position of the recovery unit which is different from that of the flowing unit in the axial direction of the developer holder roller so as to cause the liquid developer removed by the supply member cleaning unit to flow to the recovery unit through the second discharge portion, are included,
a width of the second discharge unit in the axial direction of the developer holder roller is greater than a width of the discharge unit in the axial direction of the developer holder roller, and
a position of an end portion of the second discharge unit on the second flowing opening side is disposed further towards the second flowing opening side than a position of an end portion of the discharge unit on the second flowing opening side.

11. The developing device according to claim 9,
wherein the developer holder cleaning unit has a developer holder cleaning blade which abuts on the developer holder roller, and
the recovery path member supports the developer holder cleaning blade.

12. The developing device according to claim 1, comprising:
the developer holder roller which holds the liquid developer containing the toner and the carrier liquid and is rotated about a rotation axis;
a toner charging unit which charges the toner contained in the liquid held by the developer holder roller;
a developer holder cleaning roller which abuts on the developer holder roller on a second side opposite to a first side of a second virtual vertical plane passing through a position where a virtual horizontal plane that is perpendicular to a first virtual vertical plane passing through the rotation axis of the developer holder roller intersects a peripheral surface of the developer holder roller on a first side of the first virtual vertical plane, and cleans the liquid developer containing the toner charged by the toner charging unit so as to remove the liquid developer from the developer holder roller; and
a developer holder cleaning blade which abuts on the developer holder cleaning roller on the first side of the second virtual vertical plane and cleans the developer holder cleaning roller.

13. The image forming apparatus according to claim 8,
wherein the latent image holder on which the latent image is formed; and
the developing unit which includes the developer holder roller that holds the liquid developer containing the toner and the carrier liquid and rotates about a rotation axis, a toner charging unit which charges the toner contained in the liquid developer held by the developer holder roller, a developer holder cleaning roller which abuts on the developer holder roller on a second side opposite to a first side of a second virtual vertical plane passing through a position where a virtual horizontal plane that is perpendicular to a first virtual vertical plane passing through the rotation axis of the developer holder roller intersects a peripheral surface of the developer holder roller on a first side of the first virtual vertical plane and cleans the liquid developer containing the toner charged by the toner charging unit so as to remove the liquid developer from the developer holder roller, and a developer holder cleaning blade which abuts on the developer holder cleaning roller on the first side of the second virtual vertical plane and cleans the developer holder cleaning roller, and develops the latent image formed on the latent image holder, is provided.

14. The image forming apparatus according to claim 13,
wherein the developer holder roller abuts on the latent image holder below the virtual horizontal plane in the vertical direction and develops the latent image, and
the developer holder cleaning roller abuts on the developer holder roller above the virtual horizontal plane in the vertical direction.

15. The image forming apparatus according to claim 14, wherein the supply member abuts on the developer holder roller on the first side of the first virtual vertical plane and below the virtual horizontal plane in the vertical direction, and supplies the liquid developer.

16. The image forming apparatus according to claim 13, wherein the developer holder roller abuts on the latent image holder above the virtual horizontal plane in the vertical direction and develops the latent image.

17. A recovery device provided in the developing device according to claim 1, comprising:
the recovery unit which stores the liquid developer containing the recovered toner and the carrier liquid;
a transportation member which moves the liquid developer stored in the recovery unit from one end of the recovery unit to the other end thereof; and
the recovery path member which causes the liquid developer to flow to the recovery unit and causes an amount of the liquid developer flowing to a side of the one end of the recovery unit to be greater than an amount of the liquid developer flowing to a side of the other end of the recovery unit.

18. The developing device according to claim 1, comprising:
the developer holder roller which holds the liquid developer containing the toner and the carrier liquid;
the developer holder cleaning unit which cleans the developer holder roller and recovers the liquid developer from the developer holder roller;
the recovery unit which stores the liquid developer recovered from the developer holder roller by the developer holder cleaning unit;
a transportation member which moves the liquid developer stored in the recovery unit from one end in an axial direction of the developer holder roller to the other end; and
the recovery path member which causes the liquid developer recovered from the developer holder roller by the developer holder cleaning unit to flow to the recovery unit and causes an amount of the liquid developer flowing to a side of the one end of the recovery unit to be greater than an amount of the liquid developer flowing to a side of the other end of the recovery unit,
wherein the recovery path member has a discharge portion which is disposed above the recovery unit in the vertical direction and discharges the liquid developer to the recovery unit, and wall portions disposed on the sides of the one end and the other end in the axial direction of the developer holder roller, and
the wall portions guide the liquid developer recovered from the developer holder roller by the developer holder cleaning unit to the discharge portion.

19. The developing device according to claim 18, wherein an interval between the wall portions disposed on the sides of the one end and the other end in the axial direction of the developer holder roller is narrowed toward the discharge portion.

20. The developing device according to claim 18, comprising:
a storage unit which stores the liquid developer supplied to the developer holder roller;
the supply member which supplies the liquid developer stored in the storage unit to the developer holder roller;
the supply member cleaning unit which cleans the supply member and recovers the liquid developer from the supply member;
a second recovery path member which includes a second discharge portion that is disposed above the recovery unit in the vertical direction and discharges the liquid developer to the recovery unit, and guides the liquid developer recovered from the supply member by the supply member cleaning unit to the recovery unit; and
a partitioning member which has flowing openings that cause the liquid developer to flow to the sides of the one end and the other end in the axial direction of the developer holder roller, and partitions the storage unit and the recovery unit,
wherein the discharge portion and the second discharge portion discharge the liquid developer to the recovery unit between the flowing openings in the axial direction of the developer holder roller.
